(19) United States
(12) Patent Application Publication
(10) Pub. No.: US 2018/0260753 A1
(43) Pub. Date: Sep. 13, 2018

(54) ELECTRONIC COMMUNICATIONS AND DATA STORAGE SYSTEMS AND PROCESSES FOR INDUSTRIAL PROJECTS

(71) Applicant: WERKLUND VENTURES LTD., Calgary (CA)

(72) Inventors: David Paul WERKLUND, Calgary (CA); Sean LANGUEDOC, Calgary (CA)

(21) Appl. No.: 15/757,265

(22) PCT Filed: Sep. 2, 2016
(86) PCT No.: PCT/IB2016/055282

§ 371 Date: Mar. 2, 2018

Related U.S. Application Data
(60) Provisional application No. 62/214,592, filed on Sep. 4, 2015.

(51) Int. Cl. G06Q 10/06; G06F 17/30; G06N 5/02

(52) U.S. Cl. CPC G06Q 10/06313; G06F 17/30241; G06F 17/30144; G06F 17/30979; G06N 5/022

(57) ABSTRACT

Requesting terminals access an industrial project registration system to create or modify project requests. Project requests identify unique identifiers of components or commodities needed to complete the request. A project history database can be queried with such identifiers to obtain data for the components or commodities to help build the request. A supplier is selected via any suitable bid or auction process. While the project is underway, change data is sent by a supplier party to the system to record changes due to unforeseen events. Upon completion if the request, completion data can be transmitted from a terminal and stored in the project history database for future use. Completed projects can be used to improve future project requests. Cost data for project requests are stored and communicated in a separate manner that allows for efficient review of costs related to the initial request and costs related to changes.

### FIELD

This disclosure relates to electronic communications and data systems and related processes.

### BACKGROUND

Many data systems exist for planning, scheduling, tracking and managing projects. Many of such systems suffer from drawbacks.

One drawback is that, while a system may be very good at collecting data, it is unable to output such data in a meaningful or helpful manner. Particularly with complex projects, which are defined by a large amount of data, known systems may fail to properly align known data with a new project. That is, the system may store all the data needed to setup up a new project, but that data may be trapped in the system with no efficient way of querying it to assist in quickly creating a new and accurate projects.

Systems that track project progress can also suffer from problems in efficiently keeping tracked data associated with relevant parts of the project and problems in presenting tracked data to parties that require such.

In addition, maintaining consistency of data between project request, supplier performance of project, and payment to suppliers is challenging. It is often the case that days or weeks of time pass between data events, requiring additional queries to determine which data is relevant and acceptable.

As such, the prior art suffers from reduced efficiency in data storage and retrieval, as well as in wasted processing and storage resources in compensating for reduced efficiency. Moreover, network communications are often rendered inefficient by communicating data that is not required or that is already possessed by the receiving computer but unable to be retrieved. In addition, data integrity can be compromised when human users are required to re-enter data at various instances when such data is often already present in the system.

### SUMMARY OF THE INVENTION

According to an aspect of the present invention, a process for electronically communicating data pertaining to an industrial project among a plurality of parties includes receiving requirements data captured at a requesting party terminal for a project request. The project request conforms to a predetermined schema. The requirements data specifies an industrial project to be undertaken. The process further includes determining if the requirements data includes a unique identifier of a piece of industrial equipment involved in the project, and if the requirements data contains the unique identifier, then constructing a project history query containing the unique identifier and further executing the project history query at a project history database. The process further includes extracting project history data from any project history result received from the project history database in response to execution of the project history query. The project history data specifies at least one equipment attribute of the piece of industrial equipment used in a past successful project identified by the unique identifier. The past successful project is stored at the project history database in association with a success indicator received from a past requesting party terminal. The process further includes updating the project request to contain any project history data, and transmitting the project request through a network to a plurality of supplier party terminals operated by a plurality of supplier parties for at least one supplier party of the plurality of supplier parties to undertake the industrial project using a piece of equipment having the at least one equipment attribute.

According to another aspect of the present invention, a process for recording planned and actual data pertaining to an industrial project includes receiving requirements data containing one or more locations representative of one or more of a site of the industrial project and locations between sites of the industrial project, the requirements data further identifying a piece of industrial equipment. The process further includes, while the industrial project is being carried out by one or more supplier parties, receiving from a remote terminal change data, the change data representative of a change to the industrial project as requested by a supplier party. The process further includes accumulating change data during progression of the industrial project to obtain actual project data, and computing a value of the requirements data excluding the change data. The process further includes computing a value of the actual project data including the change data, triggering an exception when the values differ by a threshold, and storing the exception in a long-term memory device.

According to another aspect of the present invention, a process for recording planned and actual data pertaining to an industrial project includes receiving from a requesting party terminal requirements data containing one or more locations representative of one or more of a site of the industrial project and locations between sites of the industrial project. The requirements data further identifies a commodity or piece of industrial equipment for a project request to be performed for the industrial project. The process further includes receiving an indication of initial cost data from one or more supplier party terminals operated by one or more supplier parties who will undertake a project request of the industrial project. The process further includes while the project request is being carried out by the one or more supplier parties, receiving from a remote supplier terminal via a network change data, the change data representative of an unforeseen change to the project request as requested by a supplier party. The process further includes associating the change data with actual cost data, storing the actual cost data separately from the initial cost data, and separately communicating the initial cost data and the actual cost data to the requesting party terminal or another requesting party terminal via the network.

These and various other aspects of the present invention are discussed in detail below.

### BRIEF DESCRIPTION OF THE DRAWINGS

The drawings illustrate, by way of example only, embodiments of the present disclosure.

FIG. 1 is a diagram of a system for registering industrial projects.

FIG. 2 is a diagram of a data structure for the system.

FIG. 3 is a flowchart of a process for constructing and transmitting a project request.

FIG. 4 is a diagram of another system for registering industrial projects.

FIG. 5 is a flowchart of a process for executing location queries.

FIG. 6 is a flowchart of a process for executing route queries.

FIG. 7 is a flowchart of a process for periodically executing route queries.

FIG. 8 is a diagram of an industrial project registration system.

FIG. 9 is a flowchart of a process of capturing road data.

FIG. 10 is a flowchart if a process of capturing completion data.

FIG. 11 is a diagram of accumulation of change data and completion data during the life of an industrial project.

FIG. 12 is a diagram of another industrial project registration system.

FIG. 13 is a flowchart of a process for detecting, storing, and communicating an exception.

FIG. 14A is diagram of a data structure for change data.

FIG. 14B is diagram of a data structure for completion data.

FIG. 15 is a flowchart of a process for capturing, storing, and approving change data.

FIG. 16 is a diagram of geo-fences.

FIG. 17 is a flowchart of a process for verifying supplier conformance to project location data.

FIG. 18A is a diagram of a user interface of a dashboard for a requesting terminal.

FIG. 18B is a diagram of a user interface for a request list for a requesting terminal.

FIG. 18C is a diagram of a user interface for a request form for creating/modifying a request at a requesting terminal.

FIG. 18D is a diagram of a user interface for location selection a request at a requesting terminal.

FIG. 18E is a diagram of a user interface of a dashboard for a supplier terminal.

FIG. 18F is a diagram of a user interface for a request list for a supplier terminal.

FIG. 18G is a diagram of a user interface for a form for responding to a request by a supplier terminal.

FIG. 18H is a diagram of a user interface for a list of bids.

FIG. 18I is a diagram of a mobile user interface for viewing an assigned request at a supplier terminal.

FIG. 18J is a diagram of a mobile user interface for indicating a new event that may include change data.

FIG. 18K is a diagram of a mobile user interface for selecting an event.

FIG. 18L is a diagram of a mobile user interface for providing change data and captured data objects.

FIG. 18M is a diagram of a user interface for outputting change data.

FIG. 18N is a diagram of a user interface for displaying actual cost data.

FIG. 19 is a flowchart of a process for performing a project request.

### DETAILED DESCRIPTION

The present invention includes systems, terminals, and related processes for executing an industrial project or a request thereof to solve at least some of the problems discussed above. The system records data pertaining to the project in a manner that allows for efficient retrieval at later instances, such as during creation of another project or request thereof. The system further provides for improved data consistency by, for example, identifying equipment used in historic projects or requests and making such available for new projects or requests. Terminals and remote systems are configured to communicate data to the system, so that data for the project or request can be tracked and stored in real-time. Potential problems during performance of the project can thus quickly come to light. In addition, costs are tracked, stored, and communicated in a manner that allows for efficient review of costs and efficient resolution of disputes and faster payment to suppliers.

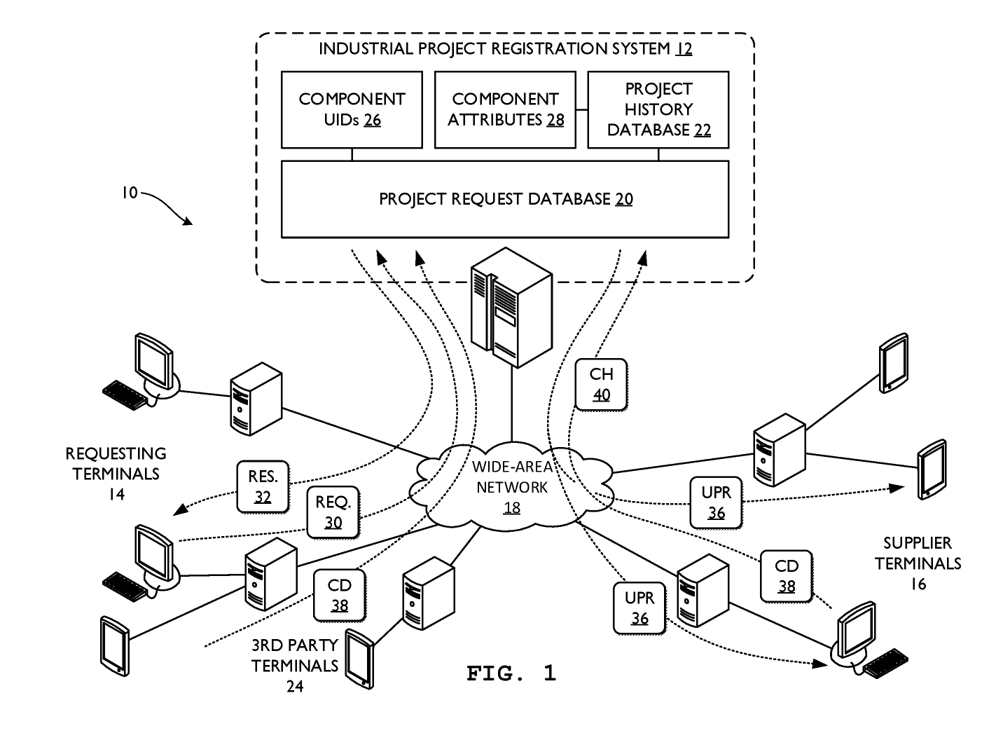

FIG. 1 shows a system 10 for processing industrial projects. The industrial project processing system 10 includes an industrial project registration system 12, a plurality of requesting party terminals 14, a plurality of supplier party terminals 16, and a wide-area network 18 for communicating data between the requesting party terminals 14 and the supplier party terminals 16 through the industrial project registration system 12.

The terminals 14, 18 include remote devices such as smartphones, mobile phones, tablet computers, notebook computers, and similar devices that are portable and operated by various parties. The terminals 14, 18 include processors and memory and are generally capable of input and output of data as well as transformation of data. The wide-area network 18 can include any combination of wired and wireless networks, such as the Internet, wireless cellular networks, satellite networks, and similar. The wide-area network 18 supports data communications and can further support the communications of short-message service (SMS) messages and/or multimedia messaging service (MMS) messages.

The requesting party terminals 14 are used by requesting parties to request supplier parties at the supplier party terminals 16 perform the industrial project. It is contemplated that requesting parties tender, commission, and/or manage projects, while supplier parties carry out the physical activities associated with the project. Examples of requesting parties include resource companies, oil companies, general contractors, project managers, and similar. Examples of supplier parties include transport companies, operators, drivers, sub-contractors, trades, and similar. Project requests are created by requesting parties and sent to supplier parties for bid and acceptance. Requesting and supplier parties may employ or be operated by various individuals with various roles, and the techniques discussed herein can be configured to assign various process steps, data requirements, or similar to various roles. The system 12 can be configured to manage roles, their responsibilities and permissions, and related workflows.

The industrial project registration system 12 includes a data store, such as one or more databases, and one or more programs executable by a processor. The system 12 includes one or more memory devices (e.g., random-access memory, hard disk drives, etc.) for implementing the data store and one or more processors for executing program code or other instructions. Memory devices can include long-term memory devices for long-term storage. The processors may be multi-core processors, distributed processors, or similar. The system 12 may be implemented as a computer server or a plurality of such servers, which may be situated together at the same location or at different locations. When more than one server is used, various different aspects of functionality can be distributed among the servers.

The industrial project registration system 12 includes a project request database 20 and a project history database 22. The project request database 20 and the project history database 22 are communicatively coupled so that data may be exchanged. The project request database 20 is configured for low-latency, high-volume data access. The project history database 22 is configured for high storage capacity archiving of data and can therefore be resident on one or more long-term storage devices.

The project request database 20 stores project requests received from the requesting party terminals 14. Project requests include data pertaining to industrial projects, which are contemplated to include activities such as the transport of equipment, material, commodities, or other payloads; the installation or removal of equipment; the connection and disconnection of utilities and services; the provision of support services; and similar. Project requests include component unique identifiers 26, such as unique identifiers of pieces of industrial equipment involved in the project (e.g., an equipment serial number), one or more physical characteristics that fully defines a commodity payload (e.g., crude oil grade, type, name, etc.), and similar.

The project history database 22 stores historic project requests with indications as to whether the projects were considered successfully completed and whether any deviations or deficiencies existed. Project history data includes component attributes 28 associated with unique identifiers 26. Component attributes 28 define characteristics about the various components of the project, such as characteristics of the equipment, material, commodities, utilities, and/or services. Component attributes 28 represent quantized characteristics, which may be represented by structured data types, such as numbers, selections from predetermined options, identifier codes, and similar. For example, an equipment attribute for a piece of equipment required for a project may indicate the weight of the piece of equipment. In another example, an attribute for a commodity may specify an equipment attribute required to safely or legally transport the commodity. The project history database 22 stores component attributes 28 in association with respective unique identifiers 26, so that the project history database 22 can be queried based on unique identifier to return any relevant component attributes 28.

The project history database 22 can further store completion data for historic project requests. Completion data can include indications of success or failure, actual start time, actual end time, actual duration, measured mileage, actual cost, deficiencies, performance ratings, approvals of these, and similar. Completion data can be stored in association with supplier party identifiers of the supplier parties who inputted the completion data or are otherwise associated with the completion data. Completion data may be received from relevant requesting party terminals 14, supplier party terminals 16, or third-party terminals 24, such as those operated by inspectors, field engineers, consultants, and similar parties. Completion data supplied by a supplier party terminal 16 may be stored and verified by a relevant requesting party terminal 14 or third-party terminal 24, which then provides further completion data in the form of a success or approval indicator approving the supplier-specified completion data.

Supplier terminals 16 are contemplated to include desktop computers, laptop computers, smartphones, tablet computers and similar. Certain supplier terminals 16 are expected to be stationary, such as those used by office personnel of a supplier party, while other supplier terminals are expected to be mobile, such as terminals used by drivers, field personnel, or other such member of the supplier party. Overlap between these roles may occur.

Supplier terminals 16 and third-party terminals 24 can be configured to capture data such as text entry, selections of options from preconfigured lists, photographs, video clips, voice recordings, recordings of telephone calls, combination of such, or similar. This applies equally to other terminals described herein, such as estimator terminals, field engineer terminals, and the like. Captured data may be electronically stamped with geographic coordinates measured by the terminal (geo-stamped), may be time stamped, may contain wireless network signatures (e.g., cellular base-station IDs), may contain other authentication measures, or may have a combination of these. Captured data can be transmitted from the terminal 16, 24 via the network 18 to the system 12. Such captured data can form or support completion data recording completion of an action in the project or change data that records a deliberate change in action needed to properly complete the project. That is, a photograph of the final delivery of a piece of equipment can be the completion data from the supplier party as to delivery of the piece of equipment. A voice recording of a field engineer confirming the deliver can be completion data supporting the delivery. Further, a video of weather conditions along the route of delivery can form change data indicating that the delivery was required to be several hours late.

The project history database 22 can further store change data representative of deliberate changes to the industrial project as requested or performed by a supplier party. Change data can be accompanied by associated additional cost data and/or time data indicative of additional cost and/or delay, and may be stored at the project history database 22 for future reference, such as audit.

In operation, a requesting terminal 14 accesses the industrial project registration system 12 to create or modify a project request 30. The data representing the completed project request 30 is transmitted by the requesting terminal 14 to the system 12 via the network 18. The system 12 stores the project request 30 in the project request database 20, identifies any component unique identifiers 26 in the project request 30, and queries the project history database 22 with any component unique identifiers 26. The project history database 22 responds with any component attributes 28 for the component unique identifiers 26, which may be provided to the requesting terminal 14 as a response 32. The project request 30 can be modified based on the response 32, by the requesting terminal 14 or by the industrial project registration system 12, to obtain an updated project request 36 that is transmitted from system 12 to one or more supplier terminals 16 via the network 18. The updated project request 36 takes advantage of the data contained in the project history database 22, so that supplier terminals 16 are provided with data that is more accurate and so that fewer data communications are necessary between the supplier terminals 16 and the requesting terminal 14 to resolve potential problems with project requests. Data accuracy can be improved and data communications can be reduced, thereby potentially reducing demands on processing and network resources. One or more supplier is selected via any suitable bid or auction process. While the project is underway, change data 40 may be sent by supplier parties to the system 12 to record deliberate changes due to unforeseen events. Upon completion of a portion of or all of a requested project, completion data 38 can be transmitted from one or more terminals 14, 16, 24 and stored in the project history database 22 for future use. The system 12 monitors the change data 40 and completion data 38 and alerts requesting terminals 14 to any exceptions or deviations that it detects. Component attributes 28 for completed projects can be used to improve future project requests 30.

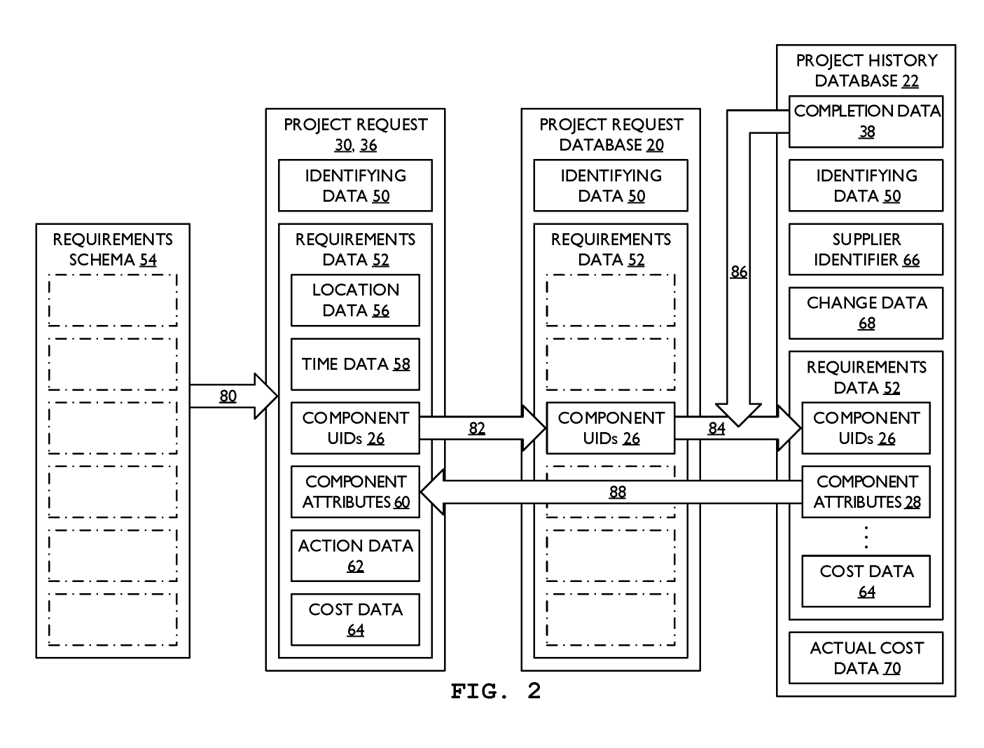

FIG. 2 shows data structures and processes for the project request database 20 and the project history database 22. Component attributes within the project history database can be extracted to improve project requests, so that less human intervention is required to configure a project request while maintaining accuracy of data within the project request and making the subsequent bid/auction process more efficient.

A project request 30, which may be an updated project request 36, includes identifying data 50 and requirements data 52. The identifying data 50 stores identifying data about the project request, such as a name, serial number, project manager identifier, project owner identifier, and similar. The identifying data 50 uniquely identifies the project request 30, 36 in the system. Status data may also be stored to track a request over its life. Example statuses include draft, posted, expired, awarded, completed, and similar. Draft requests are those under creation or modification. Posted requests are accessible to supplier terminals and can receive bids or other indications of interest. Expired requests are those whose time limits for assigning a supplier have passed (in the case of time sensitive requests). Awarded requests are those that have been assigned to a selected supplier. Completed requests are those that have been performed by the supplier.

The requirements data 52 defines the project. Each element of requirements data 52 includes, in mutual association, location data 56, time data 58, component unique identifiers 26, component attributes 60, action data 62, and cost data 64. Multiple distinct elements of requirements data 52 can exist in the same project request 30, 36. Large projects may have many elements of requirements data 52 reflective of a series of actions (e.g., transporting and erecting a drilling rig and supporting structures). Small projects may have one or several elements of requirements data 52 reflective of simpler or fewer actions (e.g., transport of 7500 gallons of crude oil from well site to depot). The requirements data 52 may be specified at a requesting terminal 14 via a suitable user interface.

Location data 56 specifies a location for an action, identified by the action data 62, to be taken. Location data 56 may be specified and stored as geographic coordinates, geo-fences, street address, legal section/subdivision (LSD), or the like. Location data 56 can further include unstructured data, such as free text, photographs, video clips, voice recordings, recordings of telephone calls, combination of such, or similar that is descriptive of the location. For example, data for a specific location may include an aerial photograph of the location to provide information to suppliers or third parties concerning the project. Such unstructured data can be linked to geographic coordinates or other indicator of the physical location in the location data 56 so that the unstructured data can be accessible for other requests at the same location. Location data 56 can include data for one or more locations where work is to be performed, origin data representative of a payload origin, destination data representative of a payload destination, route data representative of a payload move route between origin and destination, waypoint data representative of one or more waypoints between origin and destination, or a combination of such.

Time data 58 specifies date and time data for an action to be taken. Time data 58 can include one or more of a start time, end time, deadline, time limit (e.g., within 8 hours), duration, and similar. Time data can be stored in an absolute format such as UTC time (e.g., HH:MM DD-MM-YYYY).

Component unique identifiers 26 identify the components for the project. Each component can be uniquely identified by an identifier 26, although not all components are required to be identified by an identifier 26. For example, a piece of equipment may be specified by its serial number, a commodity by its grade, and similar.

Component attributes 60 may be specified to identify components of the project. One or more component attributes 60 may be specified in addition to or as an alternative to specifying a component unique identifier 26. For example, a piece of equipment may be specified by its load capacity and a number of axles. A commodity or piece of material may be specified by its defining attributes. Component attributes 60 may also be used to specify a configuration of a piece of equipment identified by a component unique identifier 26. For instance, a particular crane may be identified by its vehicle number and a component attribute may be included to specify that a certain length of spreader bar is required.

Action data 62 specifies one or more actions to be undertaken with the components of the project specified by the component unique identifiers 26 and component attributes 60. Actions include loading a commodity of piece of equipment; unloading equipment; delivering a payload; performing a trade function, such as connecting/disconnecting a utility, performing welding, etc.; setting up a piece of equipment; and similar.

Cost data 64 specifies estimated, budgeted, or expected fixed costs for the action specified in the action data 62. If the project is being put to bid, then cost data 64 can specify an internal reserve or estimate to inform acceptance of a bid. If the project is made as an offer to suppliers, then the cost data 64 can be an initial agreed cost with the selected supplier. Other uses for the cost data 64 are also contemplated and should be apparent to those of skill in the art given the benefit of this disclosure.

Each set of requirements data 52 defines an action to be carried out by a supplier with one or more components at one or more locations according to a schedule, with an associated cost.

As mentioned, requirements data 52 can be specified at a requesting terminal 14 via a user interface. The requesting terminal 14 accepts the requirements data 52 according to a requirements schema 54, which the requesting terminal 14 may obtain from the project registration system 12. The requirements schema 54 sets limits on type of data accepted for the requirements data 52 and on values for such data.

The project request database 20 stores identifying data 50 and any specified requirements data 52, such as component unique identifiers 26, for each project. The project request database 20 maintains this data and any updates to this data, while the project is ongoing.

The system 12 can be configured to duplicate active or completed requests to aid in faster performance for frequently occurring requests. Data from an active or completed request is copied to the project request database 20 and set as a new request. An example of a request amenable to duplication is delivering food or supplies to a field crew using a hotshot service.

The project history database 22 stores identifying data 50 and any specified requirements data 52, such as location data 56, component unique identifiers 26, and component attributes 28, for each project. The project history database 22 further stores one or more supplier identifiers 66 associated with each set of requirements data 52, the supplier identifiers indicating the supplier parties who are undertaking the actions identified by the action data 62. Change data 68 can also be stored in association with requirements data 52 to record any changes to the project as it was undertaken. In addition, the project history database 22 stores completion data 38 in association with requirements data 52. Completion data 38 can include a success or failure indicator, etc., as discussed above. Actual cost data 70 attributed to the associated supplier parties is stored in relation to requirements data for comparison with estimated cost data 64 established for the project request. Actual time data (not shown) attributed to the associated supplier parties is stored in relation to requirements data for comparison with time data 58 established for the project request.

Requirements data in the project history database 22 can be used to prepopulate new project request 30 to make request creation more efficient and more effective. For instance, photographs of a location for a new request 30 can be automatically fetched from the project request 30 when the new project request 30 specifies the same location as a completed request.

The project request database 20 and project history database 22 can be configured to manage access permissions based on identifying data 50, such as project owner identifier, so that only those parties authorized to access requests/projects are able to access such. For example, a company that executes projects can be prevented from accessing the projects run by another company. Requirements data 52, such as location data 56, is prevented from being exposed in an unauthorized manner to parties not designated in the related identifying data 50. Further, data access permissions can be configured, using identifying data 50, to allow access to one or more requests or completed projects by multiple different parties on a request/project basis. This can allow different companies to cooperate in the execution of the same request/project, exposing related data to each other, while still maintaining data secrecy for other requests/projects. For example, one company's photographs of a site may be useful to another company cooperating on a project at the same site.

In operation, the requirements schema 54 is enforced 80 on inputted requirements data 52 of a new project request 30. Inputted requirements data 52 that meets the schema requirements is transmitted 82 to the project request database 26. When inputted requirements data 52 includes at least one component unique identifier 26, the component unique identifier 26 is used as the basis for a query 84 to the project history database 22. The query is configured to return at least any component attributes 28 corresponding to the component unique identifier 26. Completion data 38 is applied as a condition 86 for such query, so as to, for example, limit queries to requirements data from historic projects that were successful, within budget, etc. The query is performed and any resulting component attributes 28 are passed back 88 to the project request 30. Upon acceptance of resulting component attributes 28 at the terminal 14 building the request, the request becomes an updated request 36.

The query 84 can be configured to use identifying data 50 to limit returned results to the most recent data, that is, to component attributes 28 associated with the most recent projects. Further, the query 84 can be configured to return other requirements data 52 and/or identifying data 50 with any resulting component attributes 28 in order to provide context of resulting component attributes 28 to the requesting party. Context may help the requesting party decide whether a returned component attribute 28 should be accepted.

In an illustrative example, a requesting party may enter a serial number for a drilling rig as a component unique identifier 26 when preparing a project request 30 for a project that includes transporting the drilling rig. The requesting party may provide an estimate for the weight of the rig as a component attribute 60 associated with the component unique identifier 26. The weight estimate may come from the requesting party's past experience, from documentation, or from other sources. Importantly, the weight estimate may be erroneous or out of date. The component unique identifier 26, being the serial number for the drilling rig, is transmitted to the project request database 20 and used to query the project history database 22 to obtain any component attributes 28 of the drilling rig stored in association with completion data 38 indicating project success. One of the returned component attributes 28 may be the weight of the drilling rig from a successful historic project. The requesting party may accept this weight for the drilling rig and continue with the updated project request 36. Hence, an erroneous or out-of-date weight for the drilling rig may be quickly and easily replaced by a weight associated with a successful historic project. This reduces time and cost in during performance of the project, in that the selected supplier is more likely to allocate the proper equipment to move the rig given that an accurate weight was provided. In addition, electronic communications to sort out an inaccurate weight are no longer needed, thereby saving computational and storage resources in the various communications systems.

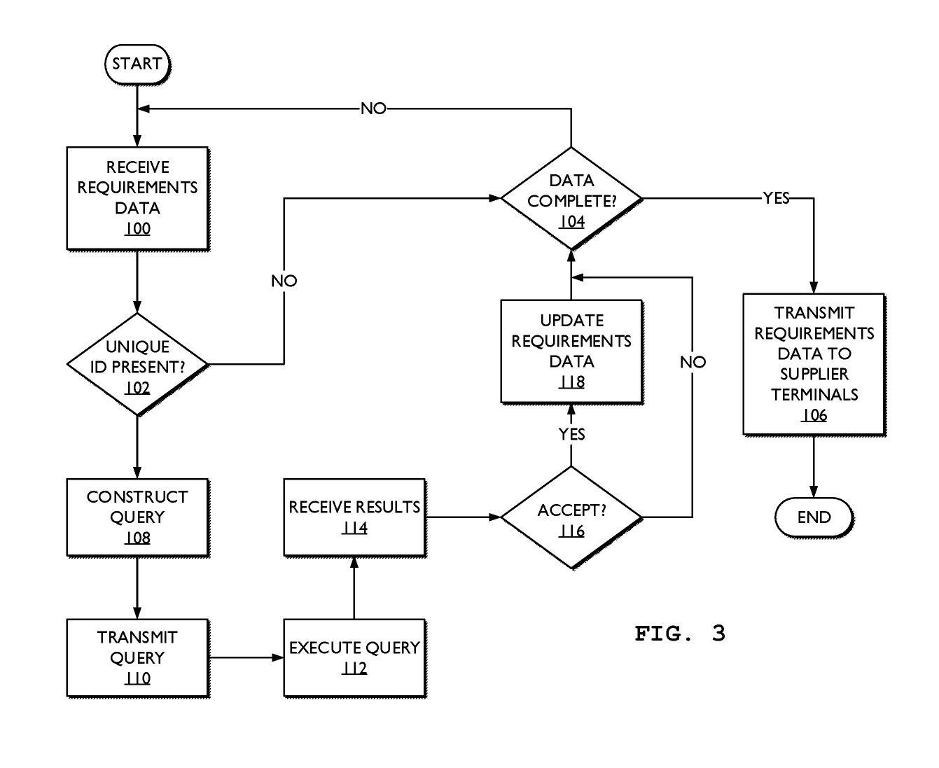

FIG. 3 illustrates a process for electronically communicating data pertaining to an industrial project among requesting and supplier parties. The process will be described with reference to the system 10 and the above description can be referenced. However, the process is not limited to the system 10 and can be performed with other systems.

At step 100, requirements data captured at a requesting party terminal 14 are received at the project registration system 12. The requirements data form a request for an industrial project to be undertaken.

Then, at step 102, it is determined whether the requirements data include a unique identifier of a component of the project, such as a piece of industrial equipment. If the requirements data does not contain a unique identifier, then it is determined whether the requirements data is complete, at step 104, before transmitting the requirements data to supplier terminals 16, at step 106. If additional requirements data are determined to be needed, at step 104, then the process returns to step 100.

If, at step 102, the requirements data are determined to contain a component unique identifier, then a project history query (e.g., query 84 of FIG. 2) is constructed at step 108. The project history query contains, as conditions, the unique identifier and the requirement for the presence of an associated success indicator, which indicates that the component identified by the component unique identifier was used in a past successful project. The query specifies that component attributes should be returned. The query may contain other conditions, limits, and specified data to be returned.

In the system 10, the project request database that handles new requirements data is distinct from the project history database that stores historic requirements data. At step 110, the project history query is transmitted or otherwise communicated from the project request database to the project history database 22.

The project history database 22 executes the query upon receipt, at step 112. Execution of the query obtains from the project history database a project history result that contains any project history data that resulted from the query. At step 114, the result is received by the project request database 20, and project history data is extracted from the result. The project history data specifies at least one component attribute, such as an equipment attribute of the piece of industrial equipment identified by the component unique identifier, that corresponds to the component unique identifier that formed the basis of the query. The absence of a component attribute in the project history result indicates that no past project using the component corresponding to the component unique identifier was successful. The presence of such a component attribute indicates that at least one such past project was successful.

A resulting component attribute can be accepted at the requesting party terminal 14, at step 116, to update the requirements data with the project history data that resulted from the query and thereby generate an updated request, at step 118. This advantageously allows data from past successful projects, and particularly data indicative of real-world equipment and success of using such equipment, to be used when constructing new project requests. Increased efficiency in constructing new project requests is expected.

Once the requirements data is complete, as determined by step 104, the updated project request containing the requirements data is transmitted through the network to supplier party terminals operated by supplier parties, so that the supplier parties can bid or otherwise compete for the project request and so that at least one of the supplier parties can undertake the industrial project.

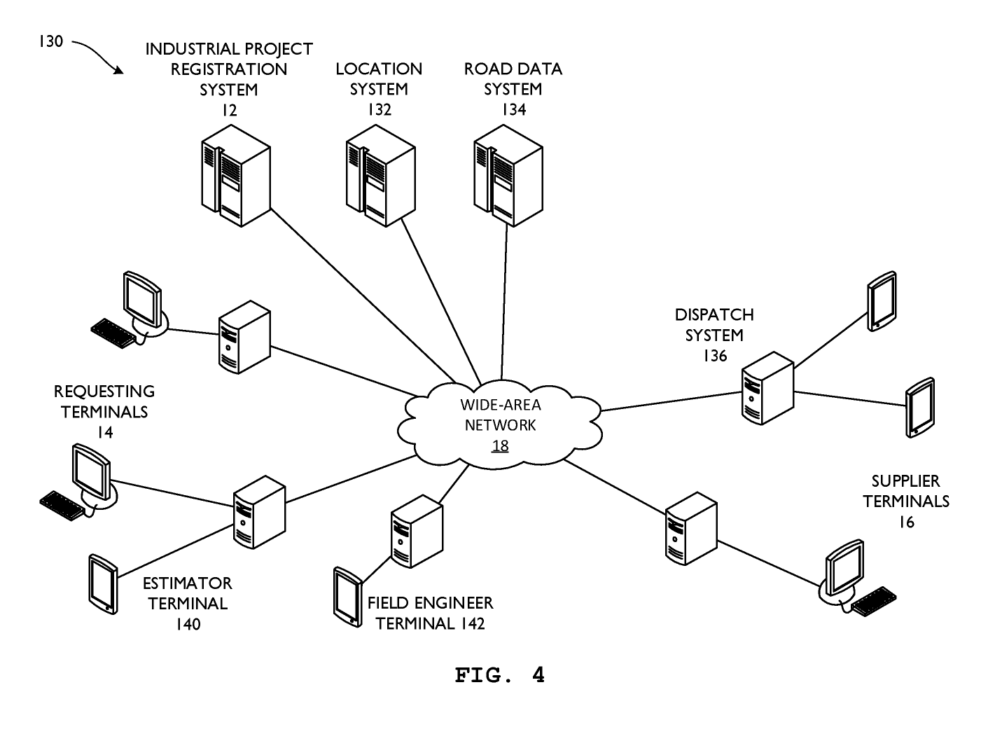

FIG. 4 shows a system 130 for processing industrial projects. The industrial project processing system 130 is similar to the system 10 discussed above. Only differences will be discussed in detail, and the above description can be referenced, with like reference numerals denoting like components. In addition to the components discussed above, the system 130 includes a location system 132, a road data system 134, one or more dispatch systems 136, at least one wireless estimator terminal 140, and at least one field engineer (or “consultant”) terminal 142.

The industrial project registration system 12 is configured to construct a location query containing one or more locations based on requirements data received for a project request. Such a location is defined by the location data 56 (FIG. 2) and is representative of a site of the industrial project or any location between sites. The system 12 is configured to transmit the location query to the location system 132, which executes the location query at a location database that forms part of the location system 132. Characteristic location data is extracted from any location query result received from the location database in response to execution of the location query. The characteristic location data, which specifies information about the location, is used by the system 12 to improve the project request. The characteristic location data includes safety attributes and site attributes. Examples of safety attributes include indications of dangerous conditions at a location (e.g., hydrogen sulphide gas, radioactive materials, etc.). Examples of site attributes include the absence or presence of utilities (e.g., electricity, gas, etc.), the absence or presence of facilities (e.g., meal services), access restrictions (e.g., narrow turn, uneven access road, low trees, etc.), and similar. The location data specified in the requirements data of the project request can be updated based on the characteristic location data extracted from the location database.

Each supplier terminal 16 may be associated with a dispatch system 136 that controls instructions and flow of data between the supplier terminal 16 and the industrial project registration system 12. The dispatch system 136 also directly instructs the supplier party at the supplier terminal 16 to carry out actions associated with the project. One or more supplier terminal 16 may be given administrative privileges at the dispatch system 136, so as to control operations of a collection of supplier terminal 16 that may be provided to supplier parties of the same supplier company.

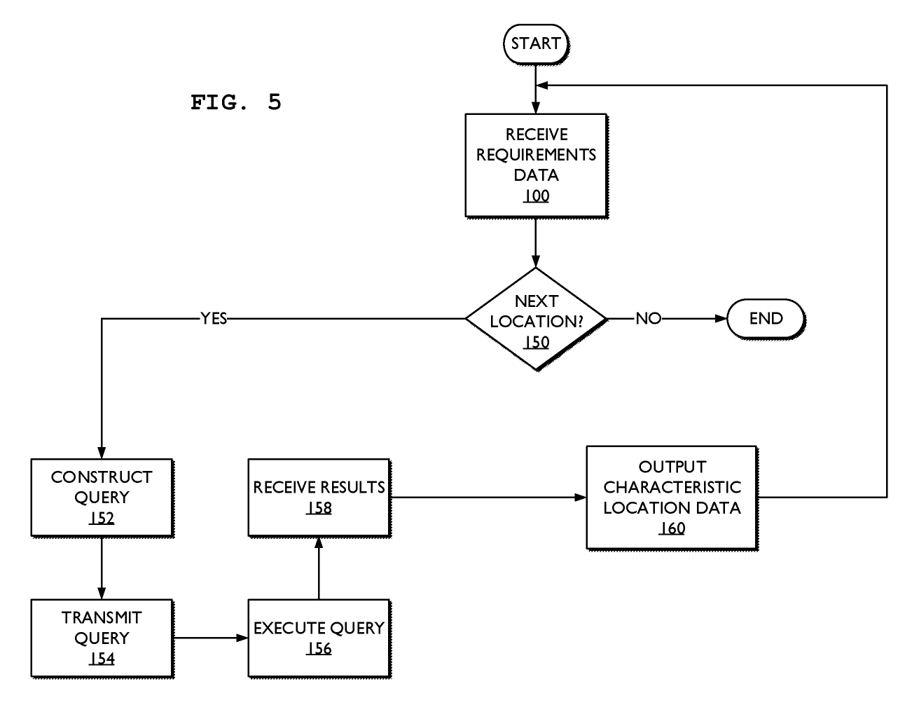

FIG. 5 illustrates a process for executing location queries. The process will be described with reference to the system 130 of FIG. 4 and the above description can be referenced. However, the process is not limited to the system 130 and can be performed with other systems.

At step 100, requirements data captured at a requesting party terminal 14 are received at the system. The requirements data form a request for an industrial project to be undertaken. The requirements data include location data 56 indicative of one or more origin, destination, waypoint, location for performing an action, or a combination of such.

At step 150, the process iterates through the provided locations, until no locations are left thereby ending the process.

For each location, a location query is constructed, at step 152. The location query takes as its condition an indication of the location in the format stored in the location database. The result of the query is configured to be any information relating to the location. At step 154, the location query is transmitted or otherwise communicated from the industrial project registration system 12 to the location system 132.

The location system 132 executes the query upon receipt, at step 156. Execution of the query obtains from the location system 132 a location query result that contains any characteristic location data that resulted from the query. At step 158, the result is received by the industrial project registration system 12, and characteristic location data is extracted from the result. The characteristic location data specifies information about the location, such as that discussed above, which can be used at the industrial project registration system 12 to improve the project request.

At step 160, resulting characteristic location data can be displayed by the industrial project registration system 12 to the requesting party terminal 14, so that any updates to the requirements data prompted by the characteristic location data can be made by the requesting party terminal 14. This advantageously allows characteristic location data to be used when constructing new project requests. Increased efficiency in constructing new project requests is expected. An initial or updated project request containing initial or updated requirements data can be transmitted through the network to supplier party terminals as discussed above with respect to FIG. 3.

With reference back to FIG. 4, projects may include moves of payloads involving a piece of industrial equipment. A piece of industrial equipment may be a transport vehicle that carries a payload, such as pipe, an oil rig, construction equipment, crude oil, and similar. The piece of industrial equipment may be a payload itself, or the piece of industrial equipment may be a vehicle that can be considered a payload that is to be moved, such as a crane or well-logging truck.

The industrial project registration system 12 is configured to construct a route query containing origin data and destination data specified in the requirements data. The origin data is representative of a payload origin and the destination data representative of a payload destination. The route query is transmitted to the road data system 134 and executed at a road database that forms part of the road data system 134. Road data is extracted from any road query result received from the road database in response to execution of the route query. The road data specifies at least one road attribute of at least one road forming at least part of a route between the payload origin and the payload destination. Road attributes include a road weight limit, a road dimension limit, a road restriction indication (e.g., seasonal road, construction, washout, other damage, etc.), or a combination of such.

A road attribute for a weight limit specifies a weight limit for a type of vehicle or per axle. A weight limit may be an absolute weight limit, in tons, pounds, or some other weight measurement. Additionally or alternatively, a weight limit may be a percentage of a standard weight limit, such as 70% of standard capacity.

A road attribute for a road dimension limit specifies a maximum dimension for a height or width for vehicles travelling on the road. The dimension may be numerical value, such as a vertical bridge clearance (e.g., 5.4 metres) or a qualitative text or image indication of a height limit (e.g., “low bridge”). The same applies for width.

A road attribute for a road restriction indication specifies information about the restriction, such as type of restriction (e.g., winter road), access opened date, access closed date, and similar.

The industrial project registration system 12 is configured to output any road attributes obtained from the query to a requesting terminal 14 preparing a project request. The project request can be updated based on the road attributes. Location data 56, time data 58, component unique identifiers 26, component attributes 60, action data 62, and cost data 64 may require changes due to road attributes. For example, a longer route may be required due to a low bridge indicated by a road attribute for a road dimension limit, so location data 56 defining waypoints for the route can be updated and time data 58 and cost data 64 reflective of the longer route can be updated as well. Alternatively, in the same example, a component unique identifier 26 may be updated to select a vehicle that has a lower height to accommodate the low bridge.

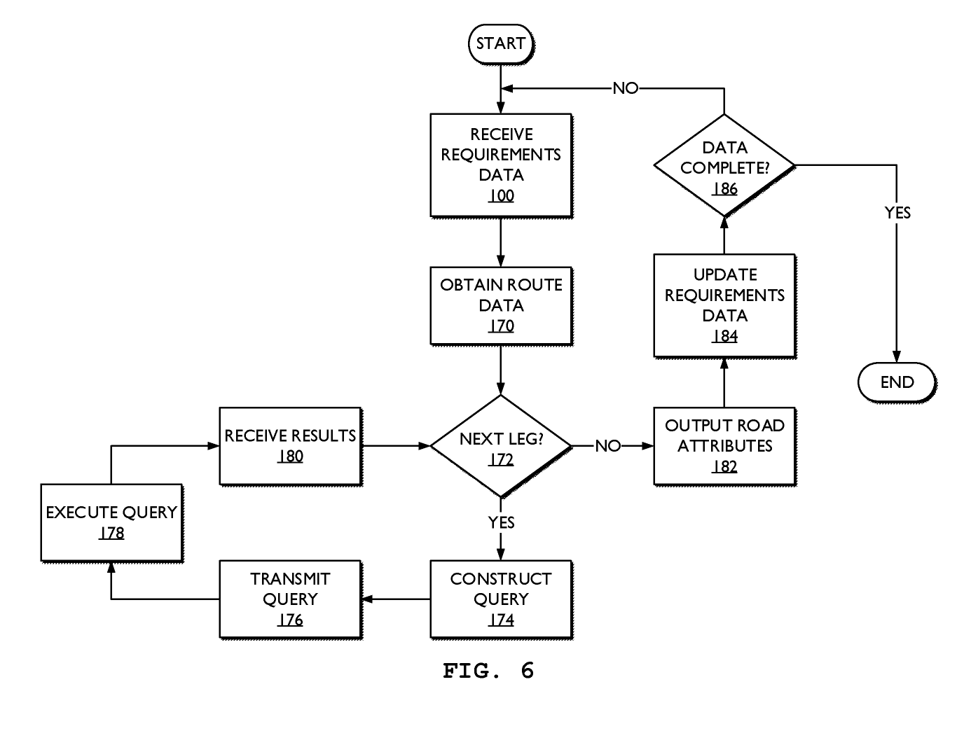

FIG. 6 illustrates a process for executing route queries. The process will be described with reference to the system 130 of FIG. 4 and the above description can be referenced. However, the process is not limited to the system 130 and can be performed with other systems.

At step 100, requirements data captured at a requesting party terminal 14 are received at the system 130. The requirements data form a request for an industrial project to be undertaken. The requirements data include location data 56 indicative of one or more origin, destination, waypoint, location for performing an action, or a combination of such.

The system 130 obtains route data, at step 170, for legs between the origin, destination, and any waypoints specified in the location data. Commercially available routing systems, such as Google Maps′, can be queried using the location data to obtain the route data.

At step 172, the process iterates through legs of the route. A leg may be specified as a road name, highway number, or other road identifier, as well as start and end points, specified as intersections, geographic coordinates, or similar, on such a road.

For each leg of the route, a route query is constructed, at step 174. The route query takes as its condition an indication of the current leg of the route. The result of the query is configured to be any information relating to the current leg of the route. At step 176, the route query is transmitted or otherwise communicated from the industrial project registration system 12 to the road data system 134.

The road data system 134 executes the query upon receipt, at step 178. Execution of the query obtains from the road data system 134 a road query result that contains any road attributes that resulted from the query. At step 180, the result is received by the industrial project registration system 12, and road attributes are extracted from the result. The road attributes specify information about the leg of the route, such as that discussed above, which can be used at the industrial project registration system 12 to improve the project request.

After all route legs are processed, at step 182, resulting road attributes can be displayed at the industrial project registration system 12 to the requesting party terminal 14 in the context of the route, so that any updates to the requirements data prompted by the road attributes can be made at the requesting party terminal 14, at step 184. This advantageously allows road attributes to be used when constructing new project requests. Increased efficiency in constructing new project requests is expected. Once the requirements data is determined to be complete, at step 186, the process ends and the initial or updated project request containing the initial or updated requirements data can be transmitted through the network to supplier party terminals as discussed above with respect to FIG. 3.

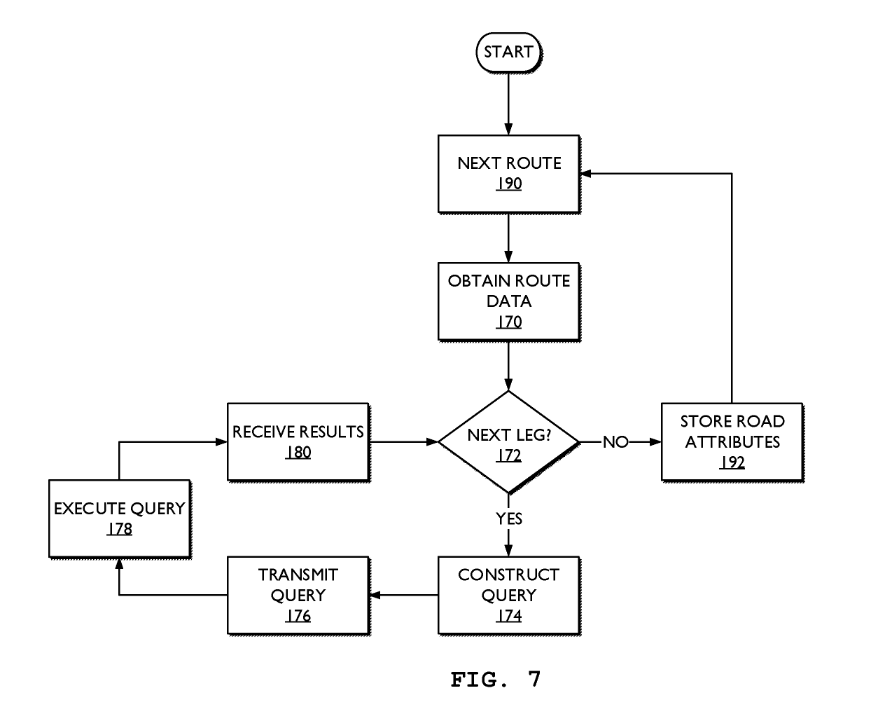

FIG. 7 illustrates a process for periodically executing route queries. The process will be described with reference to the system 130 of FIG. 4 and the above description can be referenced. However, the process is not limited to the system 130 and can be performed with other systems.

The industrial project registration system 12 can be configured to periodically perform route queries and store results of such queries for reference by future project requests.

The process iterates through a collection of routes, via selection of a next route at step 190. The collection of routes may be pre-set routes that are commonly required for project requests.

Steps 172-180 perform the road data query with the road data system 134 to obtain any road attributes, as described above, for the legs of each route.

At step 192, extracted road data, such as road attributes, are stored at the industrial project registration system 12 for reference by a future project requests. For example, the process of FIG. 6 can target a query to such stored road attributes. This advantageously allows faster access to road attributes and reduces dependency on the road data system 134, which may be an external system operated by a government agency or other entity and which may experience network downtime or other problems.

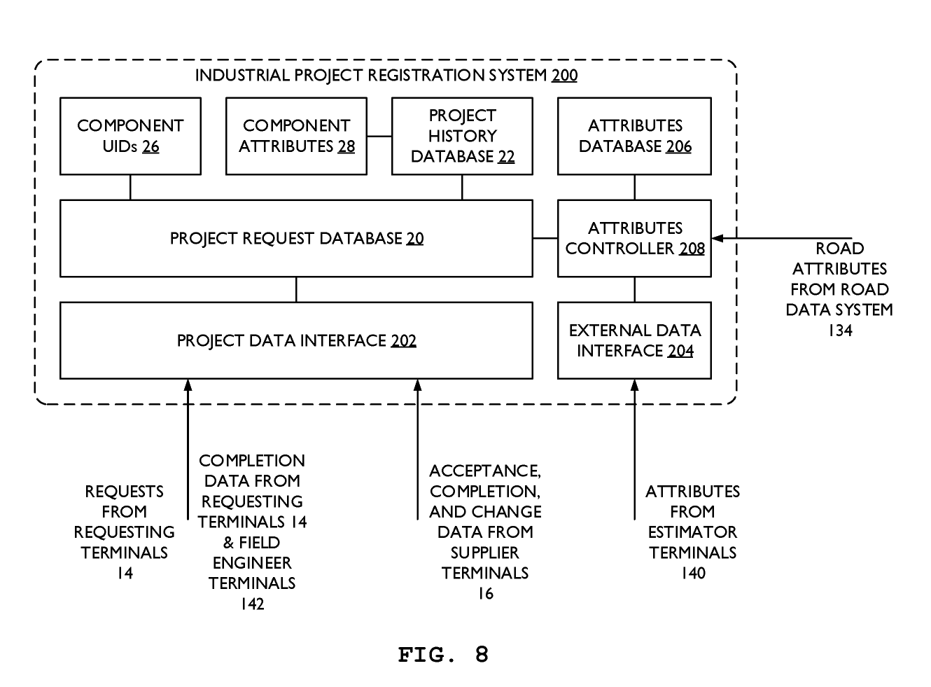

FIG. 8 shows an industrial project registration system 200 for use in systems for processing industrial projects, such as the systems discussed elsewhere herein. The industrial project registration system 200 is similar to the industrial project registration system 12 discussed above. Only differences will be discussed in detail, and the above description can be referenced, with like reference numerals denoting like components. In addition to the components discussed above, the industrial project registration system 200 includes a project data interface 202, an external data interface 204, an attributes database 206, and an attributes controller 208.

The project data interface 202 includes a network interface and a user interface configured to connect to the requesting terminals 14 and to receive from the requesting terminals 14 new and updated project requests containing requirements data as well as completion data for supplier-accepted projects. The project data interface 202 can include a web-based interface, an application interface, or a combination of such.

The project data interface 202 is further configured to connect to the field engineer terminals 142 and to receive from the field engineer terminals 142 completion data for supplier-accepted projects. The project data interface 202 can also be further configured to connect to other third-party terminals 24 (FIG. 1), such as those operated by inspectors and other parties, to receive various elements of completion data.

The project data interface 202 is further configured to connect to the supplier terminals 16 and to receive from the supplier terminals 16 indications of acceptance of project requests, completion data, and change data for accepted project requests.

The external data interface 204 includes a network interface and a user interface configured to connect to the estimator terminals 140. The external data interface 204 is configured to receive attributes from the estimator terminals 140, such as road attributes, safety attributes, site attributes, and similar. The external data interface 204 can include a web-based interface, an application interface, or a combination of such.

The attributes database 206 is configured to store road attributes, safety attributes, site attributes, and similar as received from the attributes controller 208. The attributes database 206 stores attributes to aid creation and updating of project requests as well as for project auditing. The attributes database 206 stores the road attributes outputted at step 192 in the process of FIG. 7, where such road attributes can be referenced for future project requests as well as for project auditing. Regarding the query processes discussed elsewhere herein, the attributes database 206 can be targeted with queries in the same or similar way as the location system 132 and road data system 134.

The attributes controller 208 is connected to the attributes database 206 and the external data interface 204 and is configured to receive attributes from external sources and store received attributes in the attributes database 206. The attributes controller 208 can be configured to trigger expiry of stored attributes after a predetermined time, effecting deletion of expired attributes from the attributes database 206. The attributes controller 208 can receive road attributes from the road data system, as part of step 192 in the process of FIG. 7. Additionally, the attributes controller 208 can receive road attributes, safety attributes, site attributes, and similar from the estimator terminals 140 via the external data interface 204.

Wireless estimator terminals 140 are operated by estimator parties that may visit locations expected to be involved in the project to evaluate the locations for suitability for the project. Estimator terminals 140 are configured to capture data regarding the locations, obtain attributes from captured data, and upload the attributes to the external data interface 204 for storage at the attributes database 206 to assist with creating or updating project requests, as well as for future project auditing when reviewing supplier charges. For example, a project request under creation may have several roadways as options for transport of a particular piece of equipment. The roadways may be subject to washout or unknown conditions. An estimator party can thus take an estimator terminal 140 while visiting the roadways and upload actual, measured conditions of the roadways to the attributes database 206. Text descriptions, voice recordings, photographs, video, and other data objects are contemplated for capturing the actual, measured conditions. The requesting party at a requesting party terminal 14 can then use the road attributes when constructing the request.

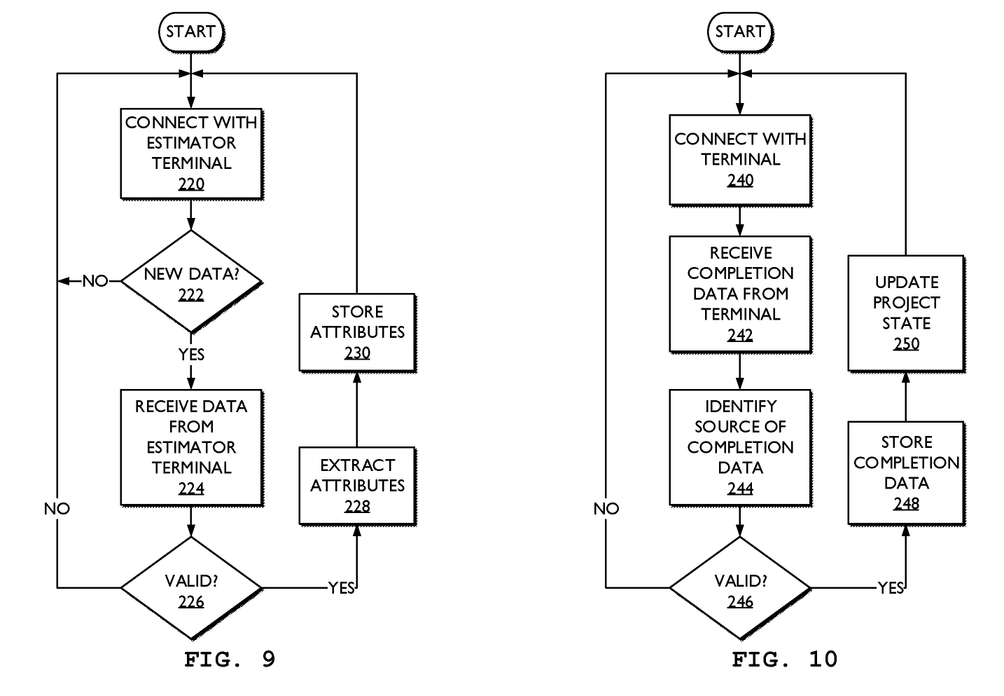

FIG. 9 illustrates a process for capturing road data. The process will be described with reference to the industrial project registration system 200 of FIG. 8 and the above description can be referenced. However, the process is not limited to the system 200 and can be performed with other systems.

At step 220, an estimator terminal 140 and external data interface 204 establish or maintain a data connection. This can be a continual function, via step 222, which checks whether the estimator terminal 140 has captured new data that should be transmitted to the industrial project registration system 200. If the estimator terminal 140 has requested to send new data, then the new data is unloaded by the estimator terminal 140 to the external data interface 204, at step 224. The industrial project registration system 200 performs a validity check on the data, at step 226, to, for example, confirm that the data contains validly specified attributes of a valid location. Attributes are extracted from data that is confirmed as valid, at step 228. Extracted attributes are stored at the attributes database 206, at step 230.

FIG. 10 illustrates a process for capturing completion data. The process will be described with reference to the system 10 of FIG. 1 and the above description can be referenced. However, the process is not limited to the system 10 and can be performed with other systems.

At step 240, a terminal, such as a requesting terminal 14, supplier terminal 16, or third-party terminal 24 and the industrial project registration system 12 establish or maintain a data connection. Establishing or maintaining the data connection includes an authentication process that can include username/password verification, a session cookie verification, a certification verification, or similar. The system 12 then receives new completion data from the connected terminal 242, at step 242, and identifies the source of the completion data, at step 244. The source of the completion data can be identifier based on the authentication process. Step 246 determines whether the completion data is valid. This can be performed by comparing the type of completion data to the identified source. For example, a supplier active on a project may submit completion data at a supplier terminal 16 for aspects of the project tasked to that supplier. A third-party inspector or field engineer at a third-party terminal 24 may submit completion data in the form of approvals of work completed by suppliers. A requesting party may submit completion data from a requesting terminal 14 as final approval of a completed project, as approval of a stage of a project, or similar. Completion data that is verified is stored at, step 248, and the state of the project can be updated, at step 250. Completion data can include text descriptions, voice recordings, photographs, video, and other data objects.

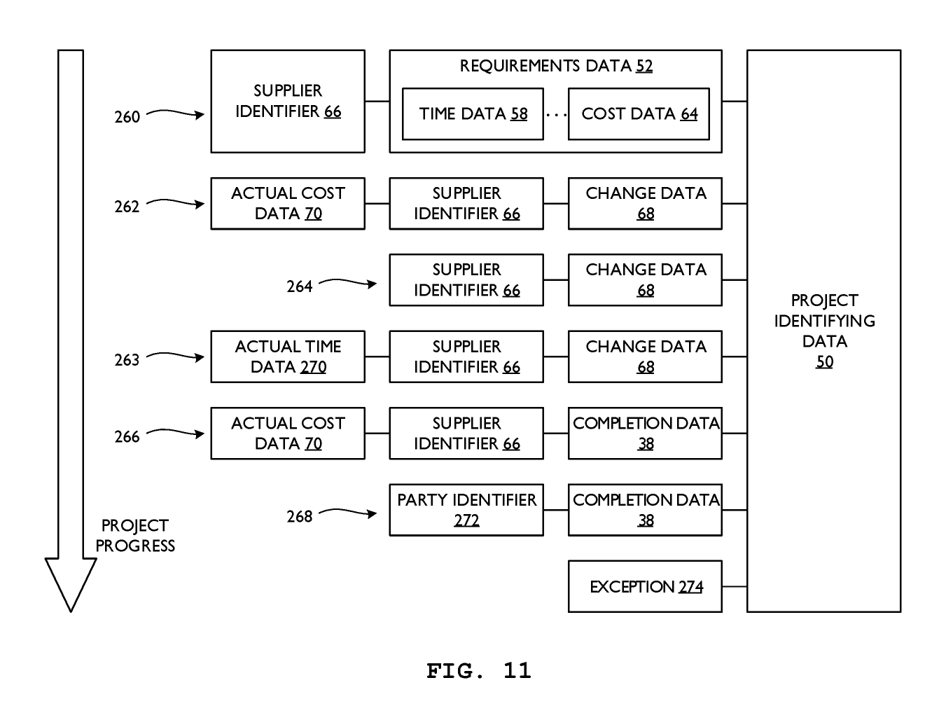

FIG. 11 shows the data structure of FIG. 2 used for accumulation of change data and completion data during the life of an industrial project. Components of the requirements data 52 are omitted from FIG. 11 for clarity and FIG. 2 and the related description can be referenced.

Each element of requirements data 52 for a project is associated with one or more supplier identifiers 66 linked to one or more supplier parties selected to perform the one or more actions specified in the requirements data 52. Requirements data 52 is linked to project identifying data 50 of the industrial project. A project may have any number of elements of requirements data 52, any number of actions, and any number of suppliers. Each element of requirements data 52 may contain cost data 64 and time data 58 that respectively specify the estimated or expected cost and time of the one or more actions specified in the requirements data 52. Upon acceptance of the project, each element of cost data 64 is agreed to by a respective supplier party linked by its supplier identifier 66. The initially accepted project request is shown at 260.

While the industrial project is being carried out by the supplier parties, the system can receive from a supplier party's remote terminal 16 change data 68. Each element of change data 68 is representative of a deliberate change to the industrial project as requested by a supplier party. It is contemplated that changes may be needed for unforeseen events, such as adverse road conditions, detour, weather, equipment failure, the failure of another party to perform prerequisite work, and similar. For example, change data can include detour data indicative of an actual road condition affecting a move portion of the project, such as the transport of industrial equipment or commodities. Change data can include weather data indicative of actual weather affecting the project. Supplier parties can submit changes by transmitting change data 68 from the supplier terminals 16 to the industrial project registration system. Changes can be configured to be approved or simply recorded for future reference, such as during supplier payment processing or audit. Approval can be configured to be made by requesting parties or third parties, as completion data 38, at any time. Approval of changes can be configured to be a prerequisite to processing payments for such changes.

Change data 68 can be associated with actual cost data 70, as shown at data element 262, in addition or alternatively to actual time data 270, as shown at data element 263. That is, a project may be subject to cost and/or time constraints, and changes affecting these constraints can be tracked. The presence of actual cost data 70 or actual time data 270 for a change may trigger an approval condition. Change data 68 need not be associated with cost data 70 or time data 270, as shown at data element 264.

Change data 68 is accumulated during progression of the industrial project to obtain actual project data, as shown by data elements 262, 263, 264.

During the course of the project, completion data 38 is received to signify completion of actions, whether successful or not, as well as data concerning completion. Completion data 38 received from a supplier terminal 38, as shown at 266, may be limited to particular data relevant to the actual completion of an action, such as actual start time, actual end time, actual duration, collectively termed actual time data 270, as well as measured mileage, actual cost data 70, and similar. Completion data 38 received from a third-party, such as a field engineer terminal 142, as shown at 268, may include approval data such as whether or not the supplier's completion is approved, approval of any changes, deficiencies in the work performed, a rating assigned to the supplier for the work done, and similar. Completion data 38 received from other sources, such as requesting terminals 14, can include similar data. Completion data 38 received from non-supplier parties can be associated with the source of the completion data via a party identifier 272.

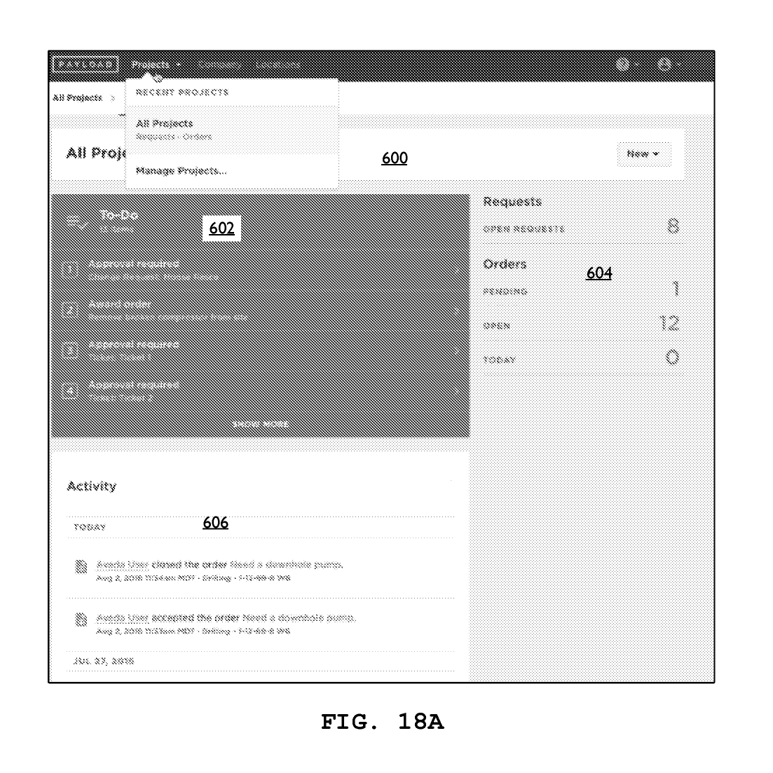

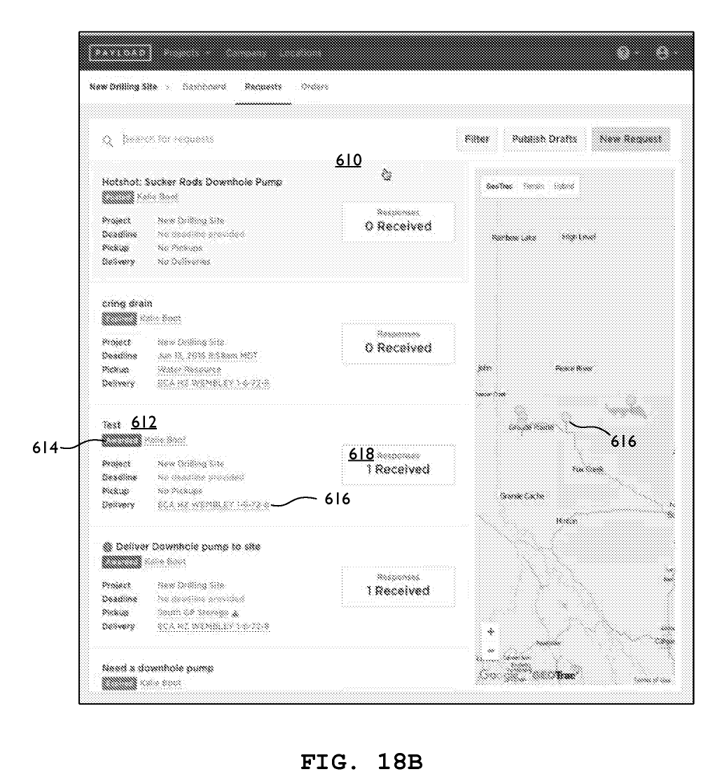

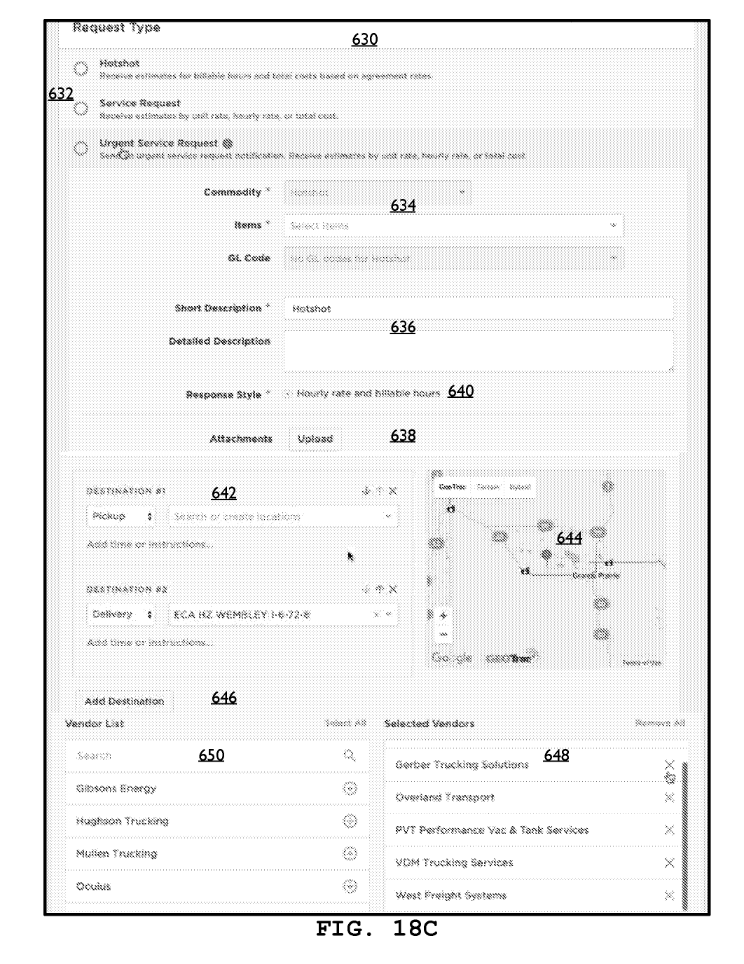

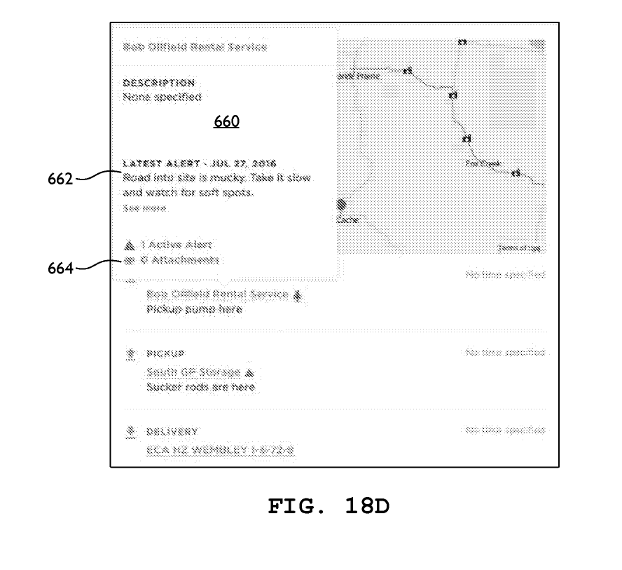

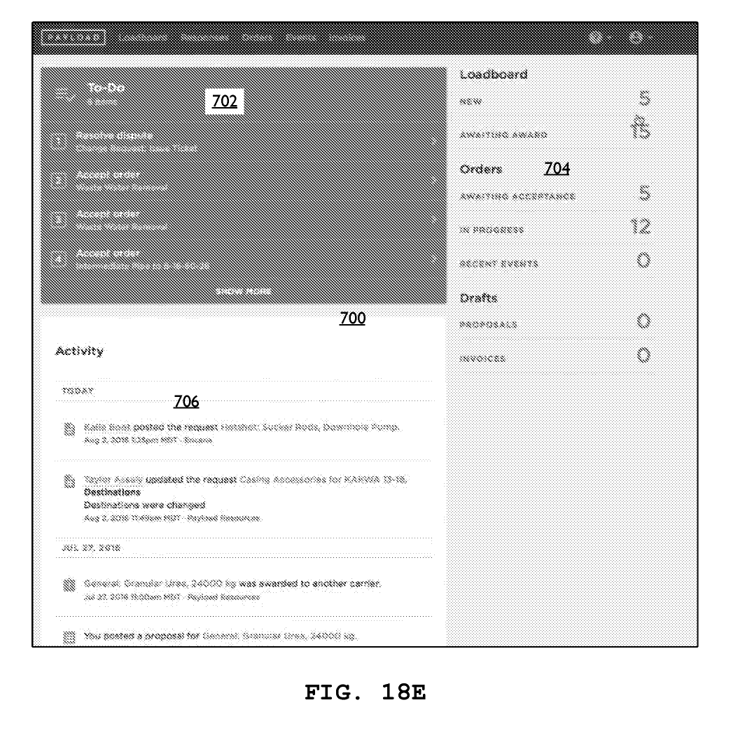

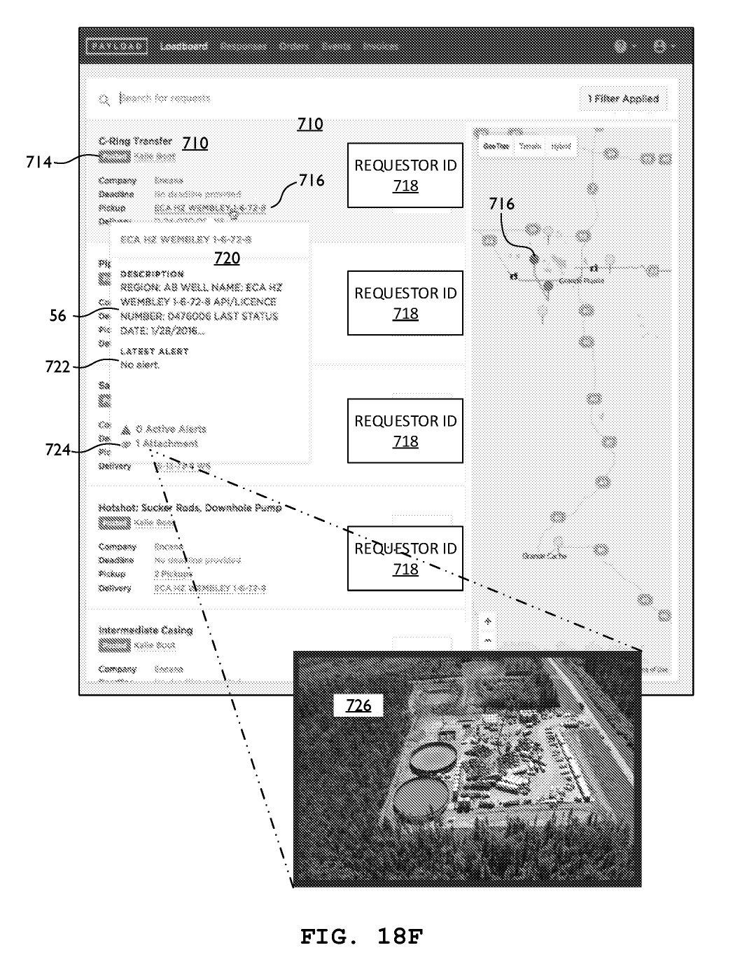

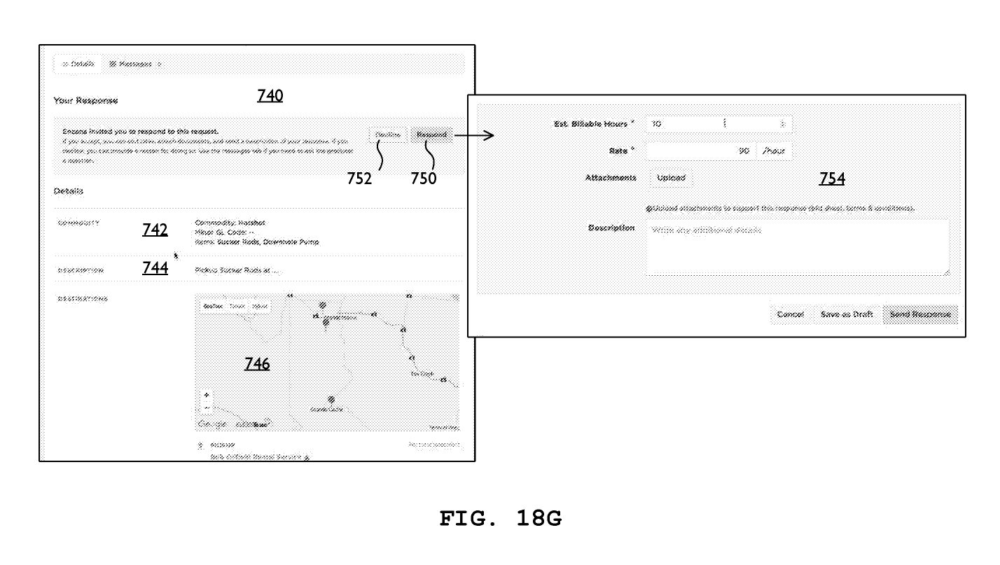

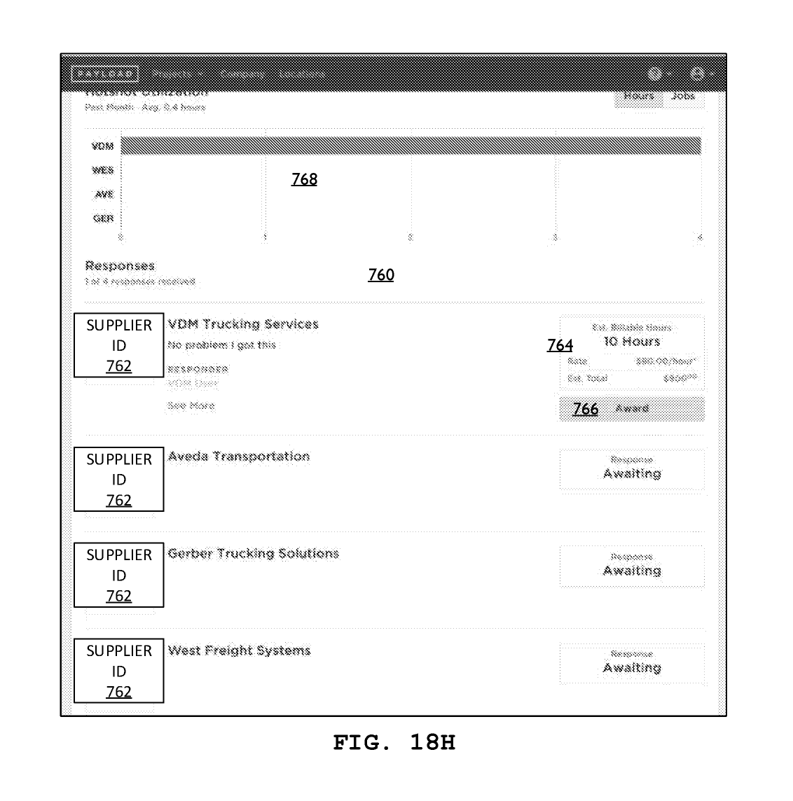

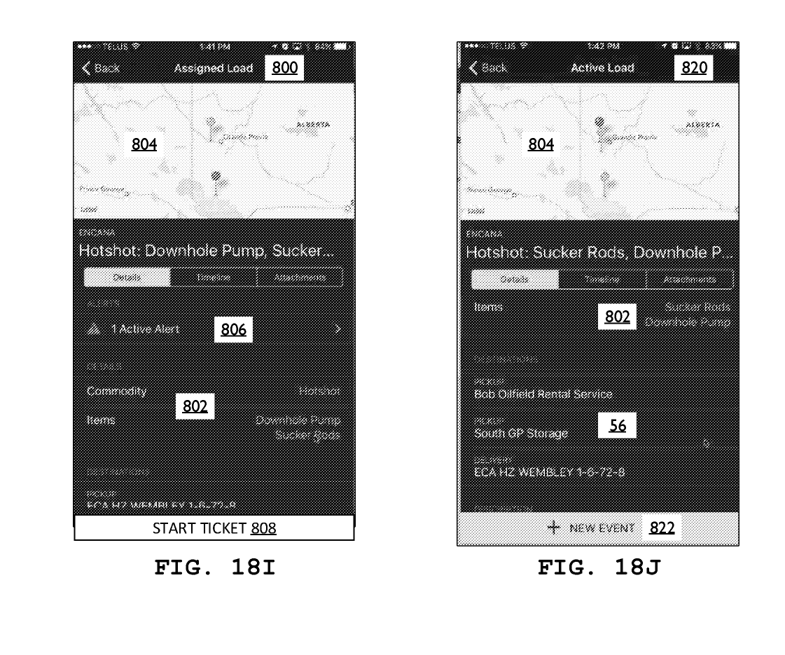

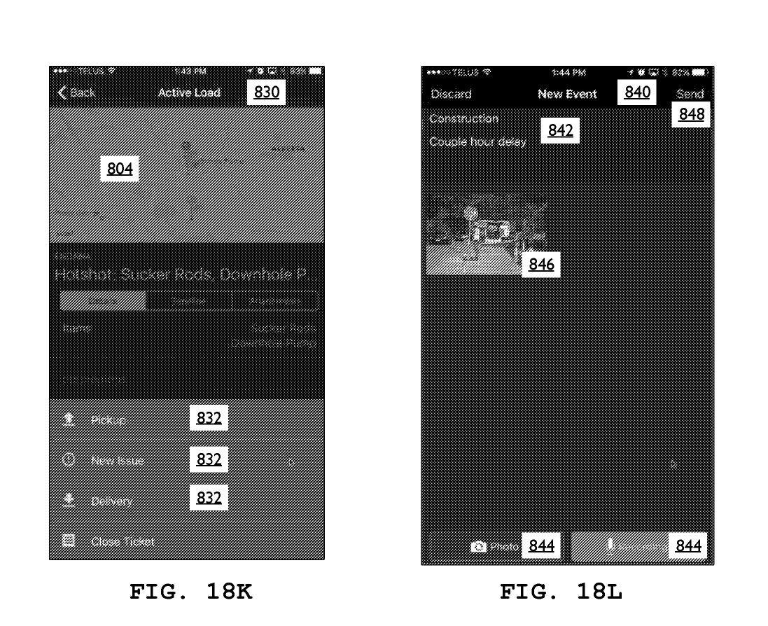

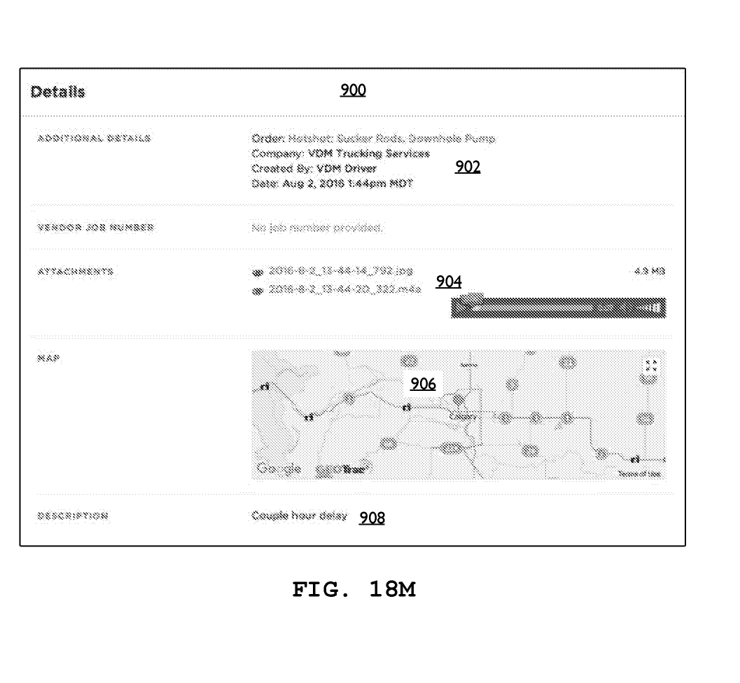

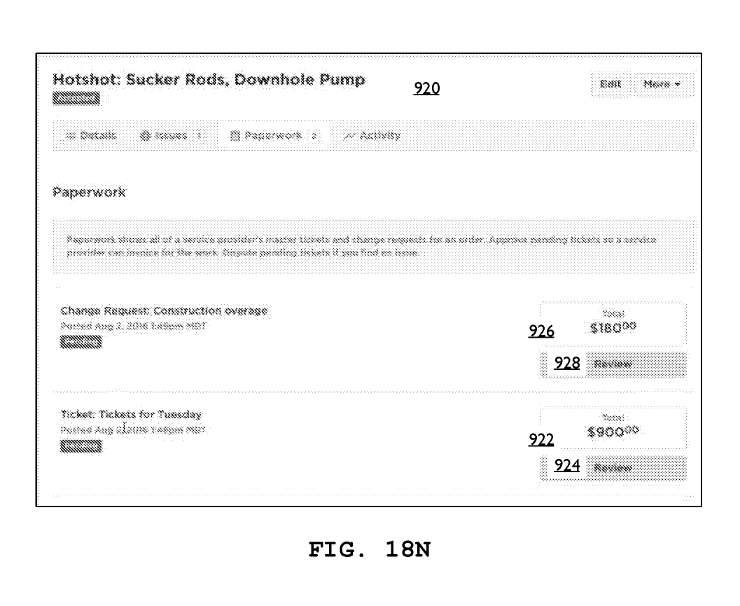

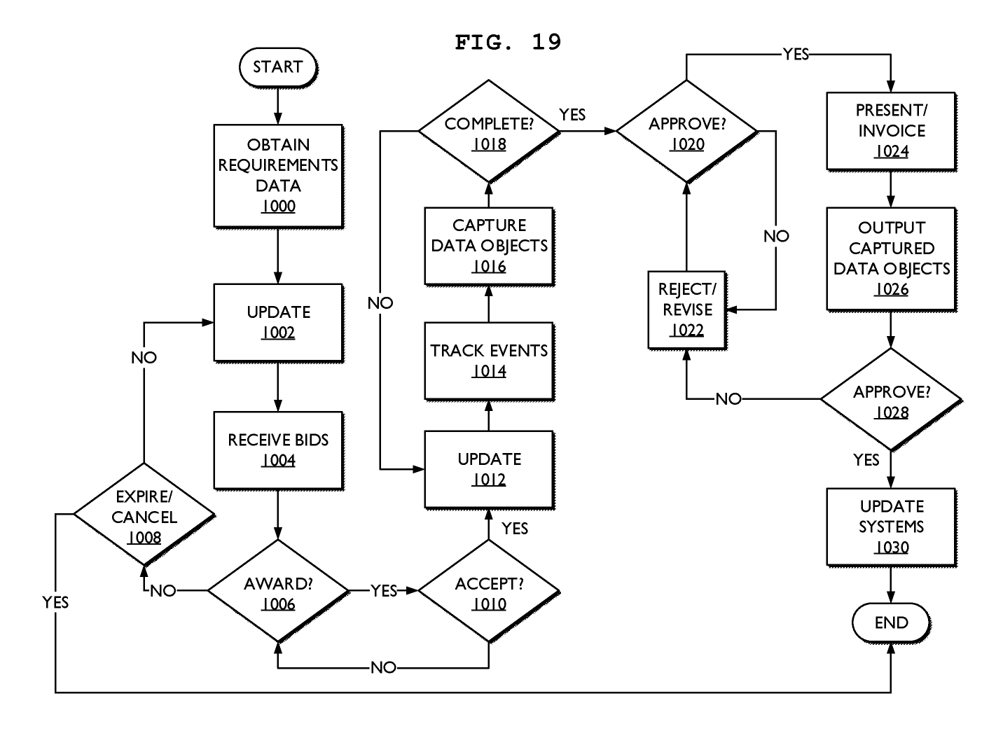

Each element of completion data 38 can be associated with actual cost data 70 reflective of the cost that the supplier party is charging for the work performed, actual time data 270 reflective of the actual start time, end time, and/or duration, or a combination of such. Cost data 64 representative of fixed costs, firm estimates, initial bids, or similar can be directly taken without change as corresponding actual cost data 70. Changes to the request can then be added as additional and separate elements of actual cost data 70 over and above the actual cost data 70 corresponding to the initial cost data 64. An example of this is shown in FIG. 18N. It is advantageous that separate discrete elements of actual cost data 70 are used for the original cost and any changes, as this gives requesting parties a clearer picture of how the project was performed and can result in faster approval of changes, which may mean faster payment for supplier parties. This is contrasted to a conventional paper ticket which may (or may not) list the original estimate and changes thereto, but often accompanies a single invoice for the ticket or a group of tickets, which makes it much more difficult to understand the performance of the project and keep costs under control.

The various data elements for changes 262, 263, 264 and completion 266, 268 can be mutually associated via unique identifiers.

Exceptions 274 can be generated based on comparisons of values in the various data elements 262, 263, 264, 266, 268. Exceptions are stored with the various data elements 262, 263, 264, 266, 268 in association with the project identifying data 50. Exceptions can include human-intelligible warnings, machine-intelligible warnings, or a combination of such. Exceptions 274 indicate that change data 68 is out of tolerance and should be reviewed, approved, or marked for future supplier review or audit.

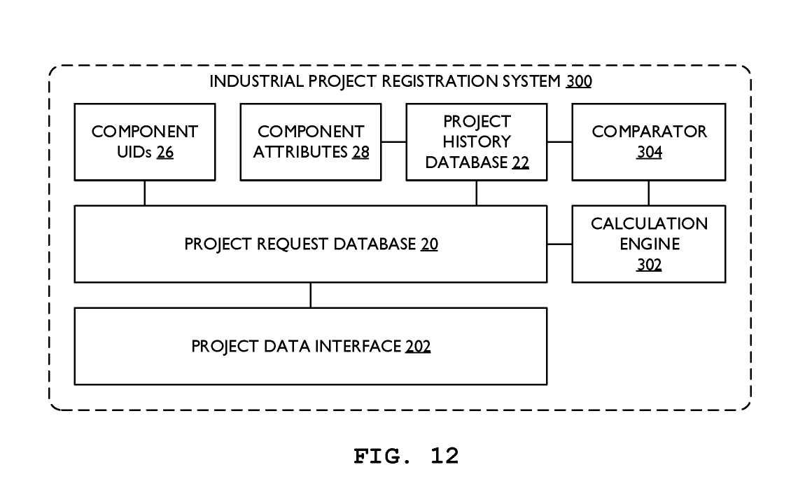

FIG. 12 shows an industrial project registration system 300 for use in systems for processing industrial projects, such as the systems discussed elsewhere herein. The industrial project registration system 300 is similar to the industrial project registration system 12 discussed above. Only differences will be discussed in detail, and the above description can be referenced, with like reference numerals denoting like components. In addition to the components discussed above, the industrial project registration system 300 includes a calculation engine 302 and a comparator 304.

The calculation engine 302 is configured to compute an actual value based on the actual cost data 70 or actual time data 270 associated with completion data 38 and to take this as the actual cost or timing of the work, excluding changes. The actual value, without changes, can be compared by the comparator 304 to a requested value computed from the cost data 64 or time data 58 that represents the projected or supplier-accepted cost or time of the project. One or both of time and cost can be processed. Financial analysis can be performed based on these values.

The calculation engine 302 is configured to also compute an actual value based on the actual cost data 70 or actual time date 270 associated with completion data 38 and including actual cost data 70 or actual time date 270 associated with change data 68, if any. The actual value, with changes, can be compared by the comparator 304 to a requested value computed from the cost data 64 or time data 58 that represents the projected or supplier-accepted cost or time of the project, and further can be compared to the actual value, without changes. Financial analysis can be performed based on these values.

The comparator 304 is configured to trigger an exception when the actual value, which is based on the actual cost data 70 or actual time data 270 associated with completion data 38 and including actual cost data 70 or actual time data 270 for change data 68, exceeds the value of the respective cost data 64 or time data 58 that represents the projected or supplier-accepted cost of the project by a threshold. The threshold may be configurable and stored in the system 300. The threshold may be expressed as an absolute value, a percentage, or similar. For example, if the supplier-accepted cost is $10,500 and the threshold is $600, then actual costs from the supplier totaling more than $11,100 will trigger an exception. In another example, if the supplier-accepted delivery time is 10:30 AM Sep. 15, 2015 and the threshold is 1 hour, then an actual delivery time from the supplier exceeding 11:30 AM Sep. 15, 2015 will trigger an exception.

The comparator 304 is configured to store the exception 274 in the project history database 22. The exception can be later retrieved when processing supplier payments, analysing historic data, auditing suppliers, or similar. The exception can be transmitted to any suitable remote terminal for review at such terminal in the context of other project data. Cost or time overruns indicated by exceptions 274 may be accepted by the project requesting party. However, one advantage of the system is that the project requesting party has a sound basis for quickly reviewing and approving or denying overruns, in the form of exceptions 274 and the associated change data 68.

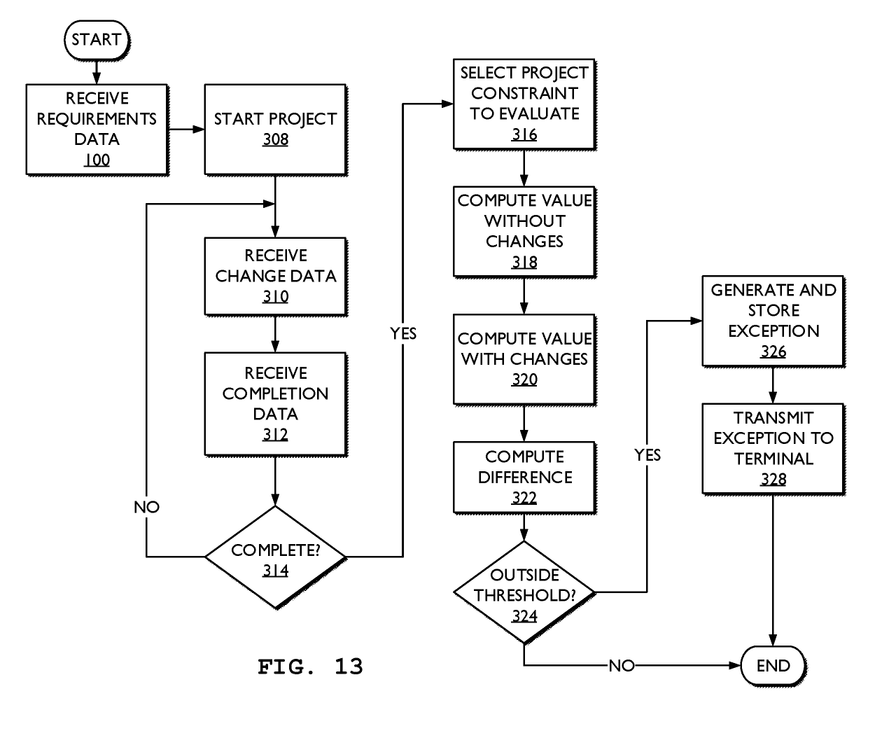

FIG. 13 illustrates a process for recording planned and actual data pertaining to an industrial project. The process will be described with reference to the system 300 of FIG. 12 and the above description can be referenced. However, the process is not limited to the system 300 and can be performed with other systems.

At step 100, requirements data captured at a requesting party terminal 14 are received at the project registration system 12. The requirements data form a request for an industrial project to be undertaken, and contain one or more locations representative of one or more of a site of the industrial project and locations between sites. The requirements data further identifies at least one project component, such as a piece of industrial equipment.

At step 308, the requirements data are processed and the project is started. This can include one or more of the processes of FIGS. 3 and 5-7, for example. One or more suppliers are selected to carry out the project via a bid, auction, or other process.

Steps 310-314 are a computer representation of the industrial project while it is ongoing, and these steps track additions to requirements data while the project is being carried out by one or more supplier parties.

At step 310, any change data is received from a remote terminal, such as a supplier terminal 16. The change data can be transmitted via any pathway within the wide-area network 18, such as a cellular data pathway, an SMS/MMS message, and similar. Change data may be queued at a supplier terminal 16 due to gaps in network coverage, and released to the network when coverage is restored. Change data is representative of a deliberate change to the industrial project as requested by a supplier party at the supplier terminal. Examples of changes include those needed for unforeseen events, such as adverse road conditions, detour, weather, equipment failure, the failure of another party to perform prerequisite work, and similar. Changes may require a delay in performance of an action, repair of a piece of equipment, addition of equipment or supplies to the project, or similar. Change data can include text entry, selection of an option from a list, a photograph, a video clip, a voice recording, a recording of a telephone call, a combination of such, or similar. Change data can include an image (e.g., a photograph, video frame, etc.) that is transmitted from a remote terminal, such as a supplier terminal 16, positioned in geographical vicinity to a piece of industrial equipment. Such an image can indicate the actual physical circumstance affecting the project. For example, a supplier's vehicle may become stuck on a road in poor conditions, in which case the change data can include text describing the incident, as well as a geo-stamped photograph of the road and vehicle. Change data can be actively sent by a supplier party taking action to send the change data. Additionally or alternatively, change data is sent automatically by the supplier terminal 16. For example, change data reflective of a detour from a route defined in location data can be transmitted from the supplier terminal 16 without action needed by the supplier party.

At step 312, completion data is received from a remote terminal, such as a supplier terminal 16, a field engineer terminal 142, or similar. This can include, for example, the process of FIG. 10. Completion data may be queued at a supplier terminal 16 due to gaps in network coverage, and released to the network when coverage is restored. Completion data is representative of completion of an action specified in the requirements data. Examples of completion data include data that indicates delivery of a payload, approval of a payload delivery, completion of a trade function (e.g., connect power, perform a weld, etc.), approval of a trade function, erecting of a structure (e.g., a drilling rig), approval of the structure, and similar. Completion data can include text entry, selection of an option from a list, a photograph, a video clip, a voice recording, a recording of a telephone call, a combination of such, or similar. For example, upon delivery of a piece of equipment to a well site, the supplier that delivered the equipment may capture a geo-stamped photograph of the equipment and may further capture a voice recording of the field engineer at the well site verbally approving delivery.

Via steps 310, 312, and 314, change data and completion data are accumulated during the progression of the industrial project. The change data and completion data form actual project data that can be compared to the requirements data established at the start of the project to define the project.

At step 316, one or more project constraints are selected for evaluation. The initial specification of a constraint can be set in the requirements data. Constraints include planned project cost and planned project time, with cost data 64 and time data 58 representing such and configurable to receive indications of constraints and respective thresholds. That is, for example, the time data 58 may indicate that the delivery time is constrained to be within 1 hour or the cost data 64 may indicate that the final cost is constrained to be within $600, with actual data falling outside the threshold triggering an exception.

At step 318, a value of the requirements data specified by a constraint and excluding any change data is computed. The value can be extracted from the requirements data, such as by obtaining a time or cost value directly. Further, operations can be carried out on several values obtained from the requirements data, such as summing or combining sub-costs to arrive at a total planned cost, determining total project time from incremental times, or similar. Data may be normalized as well, which can include converting currencies, determining absolute times from relative times or durations, and similar.

At step 320, a value of the actual project data including any change data is computed. This value can be extracted from actual data 70, 270 specified with any change data 68 (FIG. 11). Further, operations can be carried out, such as summing or combining actual time data 270 or actual cost data 70 to arrive at a final actual time or a total actual cost. Data may be normalized, which can include converting currencies, determining absolute times from relative times or durations, and similar. For example, actual time data 270 for a delay may be specified in hours, whereas the planned project deadline contained in time data 58 may be specified as an absolute time, so the delay can be converted to an absolute time for comparison purposes.

At step 322, a difference between the value of the actual project data and the value of the requirements data is computed. This can include a difference operation, such as subtracting a planned cost from an actual cost to determine any overage amount, calculating a duration of time between a planned time and an actual time to determine any time overrun, or similar.

At step 324, when the calculated difference indicates that the values differ by at least a threshold amount, then and exception is triggered. Otherwise an exception is not triggered. An exception can include a description of the constraint evaluated, an indication of the threshold, and the calculated difference.

At step 326, the exception is stored in a long-term memory device of the system for future reference, such as auditing.

At step 328, the exception is transmitted to at least one remote terminal, such as a requesting terminal 14 associated with the project. Requesting terminals 14 are contemplated to be geographically removed from the project and any industrial equipment used in the project. Hence, it can be useful to transmit exceptions to requesting terminal 14, accounting terminals, or other terminals associated with the project, so as to assist in overseeing and evaluating the success of the project as well as releasing payment to suppliers.

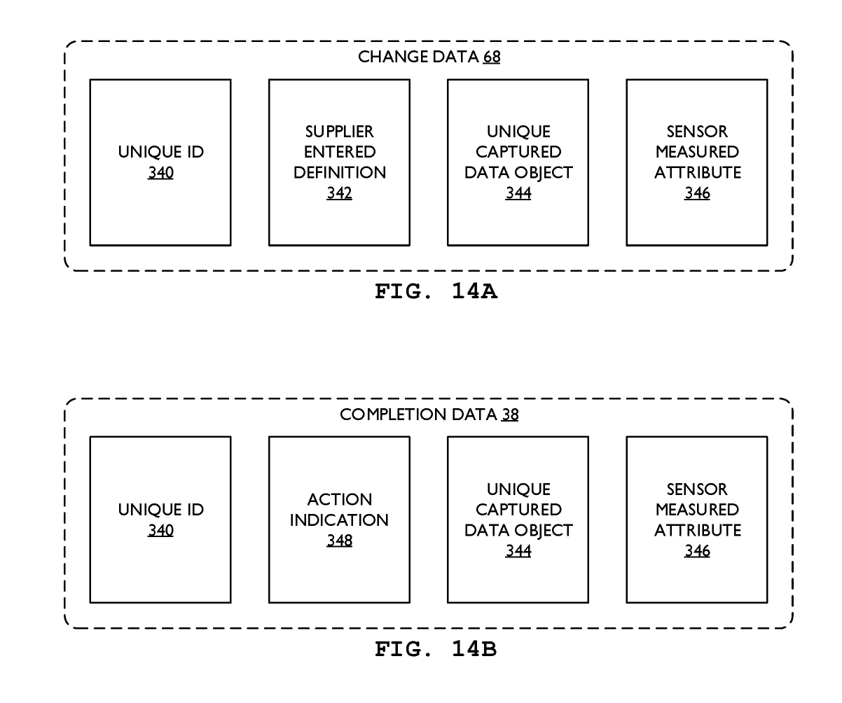

FIG. 14A shows a schematic diagram of example change data 68. The change data 68 includes a unique identifier 340, a supplier-entered definition 342, a unique captured data object 344, and a sensor measured attribute 346 stored in mutual association.

The unique identifier 340 is configured to uniquely identify an element of change data 68. The unique identifier 340 may include a serial number assigned by the system, a hash of other components 342-346 of the change data 68, or similar.

The supplier-entered definition 342 includes free text, selectable options, or similar description or data that is entered or selected at a supplier terminal 16 to define the change data 68. For example, a dropdown list is provided at the supplier terminal 16 to select from a pre-set list of specific changes and a corresponding pre-set list of change values. The pre-set list of specific changes can include options such as “Weather delay”, “Equipment failure”, “Detour”, and similar. The pre-set list of change values can be filtered based on a selection from the pre-set list of specific changes and can include options such as a selectable number of hours, a selectable cost, or similar.

The unique captured data object 344 includes one or more images, voice recordings, or a combination of such actively captured by supplier parties at the supplier terminals 16. The unique captured data object 344 is mainly composed of unstructured data that is difficult or impossible to manipulate at the supplier terminals 16. One or more images can include objects such as photographs and video indicative of an actual physical circumstance affecting the project and, if relevant, a piece of industrial equipment. Similarly, voice recordings can include a voice message indicative of an actual physical circumstance affecting the project and, if relevant, a piece of industrial equipment. Voice recordings can include recorded telephone calls.

The sensor measured attribute 346 includes data recorded by remote sensors at the supplier terminals 16 and not requiring action by the supplier parties to capture. An example of a remote sensor includes a global positioning service (GPS) device. The measured attribute 346 can represent geographic coordinates embedded in a captured image or digital sound recording. Another example sensor is a wireless communications chip in the supplier terminal 16 that can be used to record cellular base station connections, network time, and similar. The measured attribute 346 can represent approximate location and/or time.

FIG. 14B shows a schematic diagram of example completion data 38. The completion data 38 includes a unique identifier 340, an action indication 348, a unique captured data object 344, and a sensor measured attribute 346 stored in mutual association. The unique identifier 340, unique captured data object 344, sensor measured attribute 346 are similar to the change data and the above description can be referenced.

The action indication 348 is an indication as to whether an action was completed successfully or not. The action indication 348 can be entered at the terminal providing the completion data 38. For example, a supplier party may enter an action indication 348 at a supplier terminal 16 indicating that delivery of a payload is complete, and the action indication 348 may include a photograph, as a unique captured data object 344, showing the payload at the destination location. A field engineer may enter an action indication 348 at a field engineer terminal 140 accepting delivery of the payload, and the action indication 348 may include a voice recording, as a unique captured data object 344, of the field engineer verbally confirming that the payload is in acceptable condition.

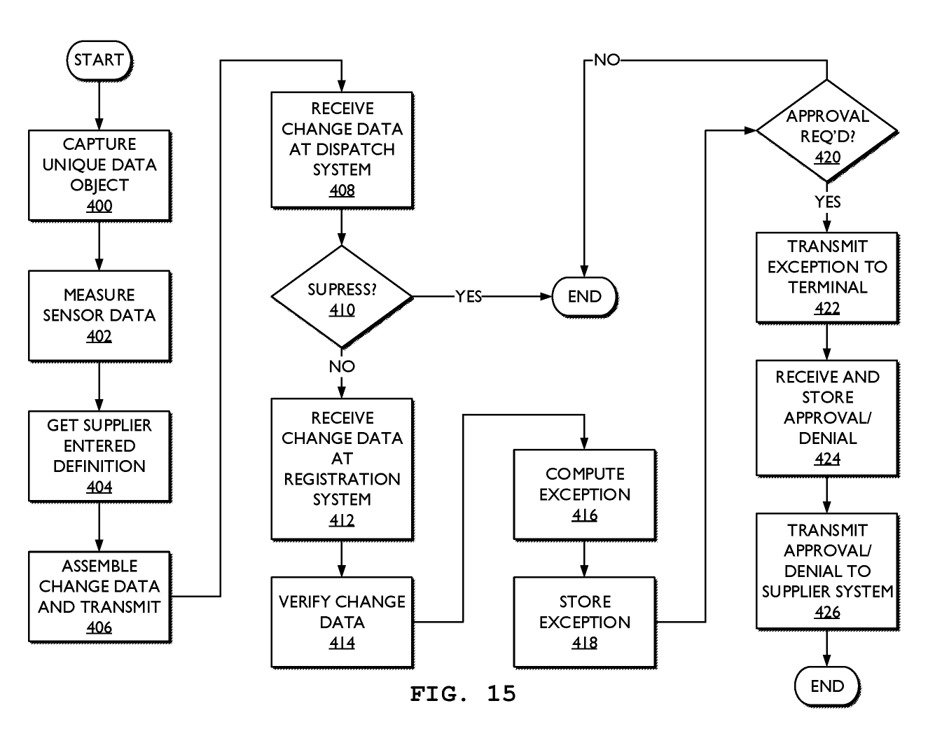

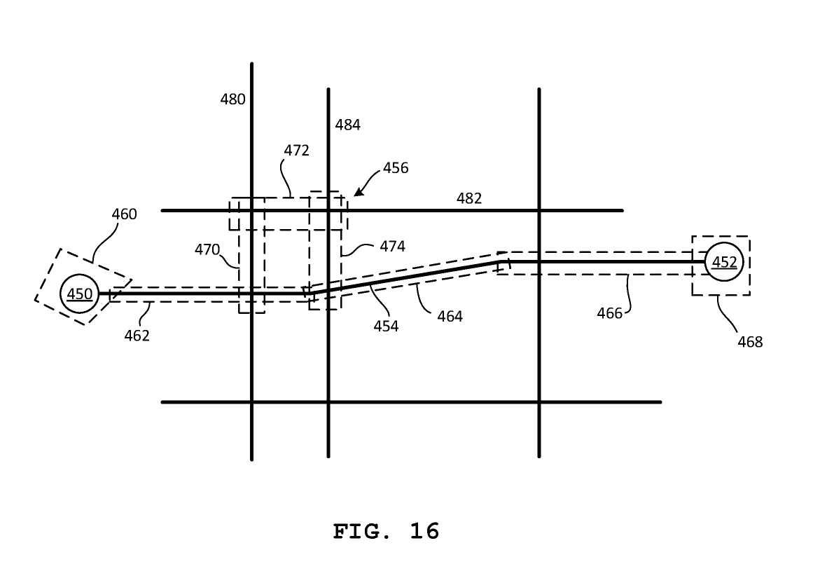

FIG. 15 shows a process for capturing, storing, and approving change data for an industrial project. The process will be described with reference to the system discussed herein and the above description can be referenced. However, the process is not limited to the systems discussed herein and can be performed with other systems.

At step 400, a unique data object 344, such as a photograph, video, voice recording, or similar, is captured at a supplier terminal 16. The unique data object 344 reflects a circumstance, in the geographic vicinity of the supplier terminal 16, that affects the performance of the industrial project. For example, a piece of equipment may have failed, and a supplier party can take a photograph of the failure with the supplier terminal 16. In another example, several transport vehicles may be waiting at a loading terminal when a supplier party arrives to accept a payload, so the supplier party can use to the supplier terminal 16 to capture a video of the queue of vehicles and capture a voice recording of the terminal manager describing the problem and the expected wait time.

At step 402, a sensor in the supplier terminal 16 automatically measures data, such as geographic coordinates, time, or similar. The measured data can be stored at the supplier terminal 16 as a sensor measured attribute 346.

At step 404, the supplier terminal 16 prompts the supplier party to enter a definition for the change data that will be formed from the unique captured data object 344 and sensor measured attribute 346. For example, the definition can be a textual or selectable description that identifies the nature of the circumstance that affects the performance of the industrial project. For example, the text may be “Waiting Time” and an accompanying time may be entered as “30 minutes”. The complete entry is stored at the supplier terminal 16 as a supplier-entered definition 342.

The unique captured data object 344, sensor measured attribute 346 supplier-entered definition 342 are assembled into an element of change data 68, at step 406. The change data 68 is then transmitted to industrial project registration system 300 via the dispatch system 136 (FIG. 4) that controls the particular supplier terminal 16. When the source supplier terminal 16 is not controlled by a dispatch system 136, the change data 68 is transmitted directly to at supplier terminal 16 that is configured to carry out the functions of the dispatch system. Alternatively, the change data 68 may be transmitted directly to industrial project registration system 300.

The change data 68 is received at the dispatch system 136, at step 408, at it is determined whether the change data 68 should be suppressed prior to being forwarded to the industrial project registration system 300, at step 410. Suppression can be performed by filters configured at the dispatch system 136 to filter out change data 68 having specific properties, such as various kinds of supplier-entered definitions 342. A supplier party may wish to avoid reporting change data 68 reflecting events of concern only to the supplier party or events that do not affect performance of the project. Erroneous change data 68 can also be eliminated at this stage. This pre-filtering of change data 68 advantageously reduces the total amount of data that needs to be transmitted to and stored by the industrial project registration system 300. In addition, change data 68 reflective of internal concerns can be kept private to the supplier party. For example, a brief vehicle breakdown that does not affect performance of the project may be handled internally by the supplier party and therefore the change data 68 reflective of the breakdown can be suppressed at step 410. Suppressed change data 68 may still be stored locally at the supplier terminal 16 or the dispatch system 136.

If the change data 68 is not suppressed, it is transmitted to the industrial project registration system 300, which receives the change data 68, at step 412

The change data 68 is then verified by the industrial project registration system 300, at step 414. Verification serves to discard spurious or erroneous data. Verification can include comparing elements of the change data 68 with elements of requirements data 52 that define the project. For instance, verifying the change data 68 can include comparing the geographic coordinates stored as sensor measured attribute 346 of an image or other unique captured data object 344 to geographic coordinates defined in location data 56 of the requirements data 52. If the change data 68 specifies a location that is too far removed from the locations of the project, then the change data 68 fail verification. While some location deviation is expected, for detours and the like, a location well removed from the project can be considered erroneous or spurious and the change data 68 can be marked as failing verification or simply discarded. In another example, a supplier-entered definition 342 is compared to action data 62 of the requirements data 52 for the project, and any supplier-entered definition 342 outside the scope of actions to be performed can be taken to indicate erroneous or spurious change data 68. For instance, supplier-entered definition 342 that indicates vehicle queue delay at a terminal triggers failure of verification for action data 62 that does not specify that transport should be carried out. In general, sensor measured attributes 346 and supplier-entered definition 342 contained in the change data 68 are compared to requirements data 52 for the project to perform verification of the change data 68.

At step 416, an exception, if any, is computed. The process of FIG. 13, of a portion thereof, can be applied.

At step 418, any exception determined is stored at the industrial project registration system 300 for future reference, such as for billing, accounting, supplier auditing, or other purposes. The exception can be stored in long-term storage, such as the project history database 22 (FIG. 1).

If approval of the exception is required, at step 420, then the exception is transmitted to an approving terminal, such as a requesting terminal 14 associated with the project, at step 422. An indication of approval or denial of an element of change data 68 is received by the system 300, at step 424, and is stored in association with the change data 68. Next, at step 426, the indication of approval or denial is transmitted to the relevant supplier terminals 16 and dispatch system 136. Steps 420-426 can be performed asynchronously with the project and need not be configured as a checkpoint for the project to proceed, which advantageously can make performance of the project more efficient and reduce demands on the terminal and the system to quickly approve changes.

FIG. 16 shows location data in the form of geo-fences that encompass a payload origin 450, payload destination 452, a move route 454, and a detour route 456.

The payload origin 450, destination 452, and move route 454 can be specified via location data 56 of requirements data 52 (FIG. 2) in a project request. Geo-fencing can be used, in which several geographic coordinates define vertexes of a shape that forms the boundary of a location or region. An origin geo-fence 460, one or more route geo-fences 462, 464, 466, and a destination geo-fence 468 form location data 56 that respectively specify the payload origin 450, move route 454, and destination 452.

A detour route 456 can be specified as change data 68 containing detour data in the form of geo-fences 470, 472, 474 that bound sections of road 480, 482, 484 forming the detour route.

The locations of supplier vehicles can be monitored by the system via GPS devices installed at the supplier vehicles, where sensor data from the GPS devices is periodically and automatically transmitted to the system. Departure from the payload origin 450 and arrival at the destination 452 can be tracked for future reference or immediate action. Further, deviation from geo-fences defining the route and any detours can be tracked for future reference or immediate action.

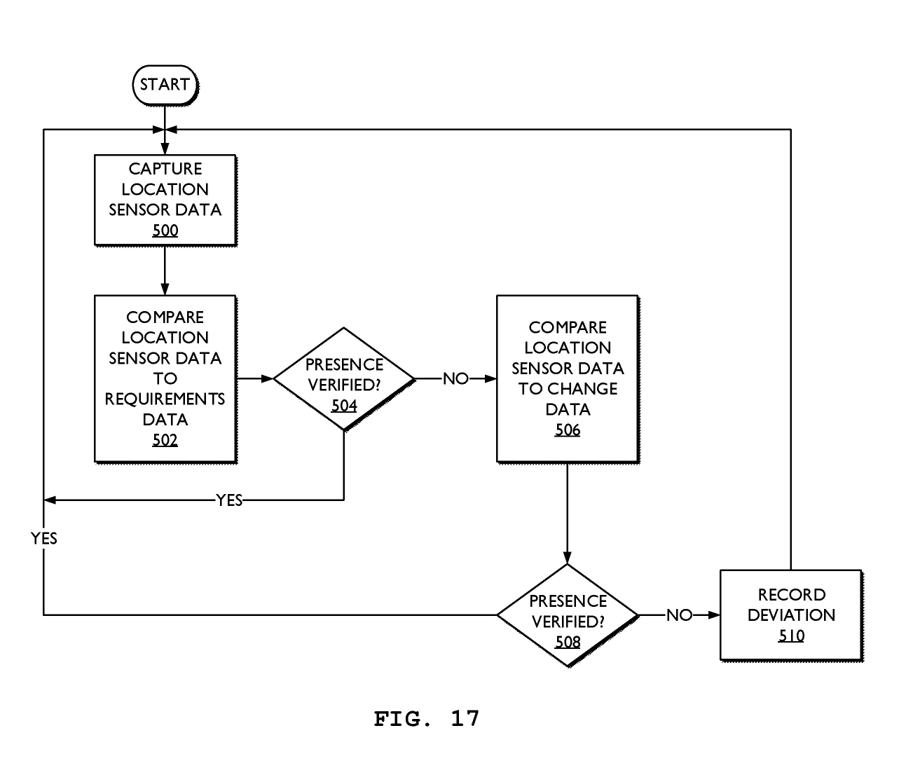

FIG. 17 shows a process for tracking supplier vehicle locations with respect to requirements data and change data that define an industrial project.

At step 500, the process captures sensor data indicative of a location of a supplier's vehicle.

The captured location is compared to locations within requirements data 52 of the project, at step 502. If the captured location matches a location within the requirements data 52, at step 504, then the supplier's vehicle is verified to be at an acceptable location and the process repeats.

If the captured location does not match a location within the requirements data 52, then the captured location is compared to locations within any change data 68, which may be reflective, for example, of a detour submitted (and approved) as change data 68 by the supplier party during the project. If the captured location matches a location within change data 68, at step 508, then the supplier's vehicle is verified to be at an acceptable location and the process repeats. Any cost or time overrun will be tracked by the change data 68. The purpose of step 506 is to ensure that deviations from submitted or agreed change data 68 are tracked.

Comparison steps 502, 506 can refer to a geo-fence of a payload origin defined in requirements data, a geo-fence of a payload destination defined in requirements data, a geo-fence of a portion of a move route defined in the requirements data or any detour defined in change data, or a combination of such.

Step 510 records a deviation from locations specified in the requirements data 52 and locations specified in the change data 68. Deviations can be recorded in the system as unapproved change data, as exceptions, or in another manner.

FIGS. 18A-18N show user interfaces as displayed at various terminals 14, 16, 24. The user interfaces implement functionality discussed above and can be implemented as web-based interfaces, application interfaces, or a combination of such using processing and data resources of the terminals 14, 16, 24, processing and data resources of the system 12, a combination of such, or similar.

FIG. 18A shows a dashboard 600 for a requesting terminal 14. A pending task list 602 element displays tasks that need action to be taken by a requesting party. Such tasks include approving change requests containing change data 68, selecting a supplier for a new request (award order), approving completion of a request (ticket), and similar. A request summary element 604 displays total counts for unassigned requests and requests assigned to suppliers. In addition, a log of recent activity 606 on requests can be displayed.

FIG. 18B shows a request list 610 for a requesting terminal 14. Requests 612 and their statuses 614 are listed showing key data in conjunction with a map that displays locations 616 of the requests. Indications of responses 618 from supplier terminals 16, such as a count or other data, can also be displayed for the requests 612.

FIG. 18C shows a request form 630 for creating/modifying a request at a requesting terminal 14. A service type selector 632 is configured to allow selection of different properties for the request such as rate types, cost presentation, billing practices, and similar. A commodity and component selector 634 is configured to allow selection of a commodity and/or component for the service. The commodity and component selector 634 can be used to specify one or more component unique identifiers 26 to be stored with the requirements data 52. Accounting data, such as GL codes, can also be selected or pre-configured based on selections made via the service type selector 632 and commodity and component selector 634. Further provided are one or more data entry fields 636 and/or attachment upload elements 638 for specifying other requirements data 52, such as a textual description of the request, photographs of the site/component, or similar. A response style indicator/selector 640 can be provided to indicate or set the type of response required for the request, such as an indication of cost presentation style, which can be stored with cost data 64. One or more location and time selectors 642 are provided to allow selection of a locations (e.g., origin, destination, pickup point, drop off point, waypoint, etc.) for the request with the optional selection of times required (e.g., pick up by time, deliver by time, etc.), which can be stored as location data 56 and time data 58. Indications of selected locations and times can be presented on an adjacent map 644. A location and time adder button 646 can be provided to add additional location and time selectors 642 as needed, so that complex routes with multiple pick ups and drop offs can be created. In addition, selected supplier parties 648 invited to see and/or bid on the request can be selected using a supplier list tool 650 that list all supplier parties available.

FIG. 18D shows a location selector 660 for selecting a location for a request made at a requesting terminal 14. The location selector 660 can be configured to allow selection of location (e.g., component origin, destination, waypoint, etc.) based on name, identifier, LSD, geographic coordinates, or similar. The location selector 660 can be configured to provide road/site condition data 662, which may be obtained from the road data system 134, during selection of a location. The location selector 660 can be configured to provide unstructured location data, such as photographs and the like, via an attachment selector 664.

FIG. 18E shows a dashboard 700 for a supplier party terminal 16. A pending task list 702 element displays tasks that need action to be taken by a supplier party. Such tasks include resolving disputed change requests containing change data 68, indicating to a requesting party the acceptance of a request (accept order), and similar. An order summary element 704 displays total counts for requests/orders concerning the supplier. In addition, a log of recent activity 706 on requests/orders can be displayed.

FIG. 18F shows a request list 710 for a supplier terminal 16. Requests 712 and their statuses 714 are listed showing key data in conjunction with a map that displays locations 716 of the requests. Indications of owners/requestors 718 of the request, that is for example, the requesting parties, can also be displayed for the requests 712. A location data element 720, such as a popup frame or window, can be provided to display location data 56 as well as road or site condition data 722, which may be obtained from the road data system 134. In addition, an attachment selector 724 can be provided to output unstructured location data, such as photographs 726 of the site or roads and the like, so that can be fully evaluated at supplier terminals 16 of supplier parties considering bidding on or accepting the request.

FIG. 18G shows a user interface of a form 740 for a supplier terminal 16 to provide a response to a request. In this example, the supplier party provides a bid. A commodity and component identifier 742 is provided to display data concerning of the commodity and/or component that is the subject of the request. One or more description fields 744 are also provided to display the nature of the request, along with a map 746 showing the origin, destination, and/or other location data 56 related to the request. The form 740 includes a respond button 750 and a decline button 752. The decline button 752 can be configured to prompt the supplier party to enter a reason for declining the request, the system being configured to transmit the reason to the relevant requesting terminal(s) 14. This can provide a feedback loop for requesting parties to improve their requests. The respond button 750 triggers display of a response data form 754 that is configured to receive details of the response from the supplier terminal 16. Response data can include estimated cost data, enterable in the cost presentation style selected when the request was created, as well as a response text input element and an attachment upload element to allow the supplier party to provide additional information about the response. Submit, save, and cancel buttons are also provided to process the response accordingly.

FIG. 18H shows a listing 760 of bids or other indication of interest from supplier parties. The listing 760 is configured to be presented at the relevant requesting party terminals 14. Supplier identifiers 762 of supplier parties who have been invited to bid on completing the request, or otherwise indicate interest in such, are listed with data concerning the supplier parties and data concerning their responses. Bid data 764, including cost and time data, is presented with the supplier identifiers 762 of those supplier parties that have provided a response to the request. An award button 766 is provided for each element of bid data 764 and is configured to assign the request to the associated supplier party, so that any bid data 764 can be immediately accepted (subject to acceptance of the award by the supplier party). In addition, a graph 768 can be displayed to visually represent the responses received. In this example, the graph shows a count of responses received from the various supplier parties.

FIG. 18I shows a mobile user interface 800 for viewing an assigned request (ticket) at a supplier terminal 16, and more particularly a mobile supplier terminal operated by a driver or other member of the supplier party. Requirements data 52 defining to the request, such as commodity/component data 802, location data 56 rendered in text and displayed on a map 804, and time data 58, can be displayed at the user interface 800. Road/site condition data 806, which may be obtained from the road data system 134, can also be displayed. A start button 808 is provided for the driver or other individual to begin working on the request.

FIG. 18J shows a mobile user interface 820 for indicating, at a supplier terminal 16, a new event that may include change data during the performance of a request. The user interface 820 includes a new event button 822 for indicating the occurrence of a new expected or unexpected event. Expected events include pickup of commodity/component, drop off of commodity/component, arrival at or departure from a location, and similar. Unexpected events include traffic, weather delays, and other such events as discussed elsewhere herein. For example, the driver may use the new event button 822 to begin the process of indicating that he/she has encountered a construction delay while on delivery.

FIG. 18K shows a mobile user interface 830 for selecting, at a supplier terminal 16, an expected or unexpected event. The user interface is configured to be displayed in response to pressing the new event button 822 of the user interface 820 of FIG. 18J. A plurality of event indicating buttons 832 are provided to allow the user to quickly indicate the type of event. Buttons 832 may be provided for pickup, delivery, and a new issue or unexpected event, for example.

FIG. 18L shows a mobile user interface 840 for providing, at a supplier terminal 16, change data 68 and unique captured data objects 344 related to an unexpected event during performance of a request. The user interface 840 includes one or more input elements 842 configured to allow input or selection of text descriptions of unexpected events. One or more capture buttons 844 or other user interface elements are provided to capture data objects 344, such as photographs, voice recordings, and/or similar as discussed elsewhere herein. Representations 846 of data objects 344 can be displayed in the user interface 840 to allow for confirmation and/or deletion. A send button 848 is provided to trigger the supplier terminal 16 to transmit change data 68, unique captured data objects 344, and sensor or other data 402 (e.g., a GPS location of the supplier terminal 16) representative of the unexpected event to the industrial project registration system. In one example, a driver enters text describing a construction delay using input element 842, presses a capture button 844 to take a photo of the road construction, and then presses the send button 848 to transmit such to the industrial project registration system.

FIG. 18M is a diagram of a user interface 900 for outputting change data. The user interface 900, or one similar thereto, can be used at requesting and supplier terminals 14, 16 to review changes to a request during the performance of a request. A supplier terminal 16 can be configured to review and approve changes for presentation to a requesting party as, for example, support for actual costs 70 associated with changes to requests. A requesting terminal 14 can be configured to review and approve changes in the context of approving invoices for actual costs 70. The user interface 900 displays data 902 pertaining to the request, including a supplier party identifier and time data of the change. Further included are indications, such as links, of captured data objects 344 for the change that are configured to output the captured data objects 344 for review, as well as a map 906 showing location data 56 associated with the change. A text description 908 of the change is also provided.

FIG. 18N is a diagram of a user interface 920 for displaying actual cost data for a completed request. The user interface 900, or one similar thereto, can be used at requesting and supplier terminals 14, 16 to review costs associated with the request and changes thereto. An indication 922 of original or estimated cost data 64 is displayed for the request, which may be the cost associated with the winning bid, in conjunction with a review button 924 configured to display details related to the cost, including requirements data 52 and completion data 38. An indication 926 of actual cost data 70 associated with a change is displayed in conjunction with a review button 928 configured to display details of the change, such as change data 68 and unique captured data objects 344 (e.g., photographs, voice recordings, etc.), which may be outputted via the user interface 900 of FIG. 18M. It is advantageous that actual cost data 70 is tracked and displayed separate from original or estimated cost data 64, as this gives the various parties involved in the request a clear picture of the costs associated with the requests and the supporting reasons and evidence. Requesting parties benefit by having costs clearly specified, and supplier parties benefit by potentially faster approval of invoices and faster payment.

FIG. 19 shows a flowchart of a process for performing a project request using the techniques discussed elsewhere herein, including using the industrial project registration system.

At step 1000, the request is created and requirements data 52 is obtained for the request. This can include entry of requirements data 52 at a terminal, obtaining historical data, and obtaining data (e.g., road conditions) from other system 132, 134. The request is then displayed to supplier parties for bidding, auction, similar. See FIG. 18C for a suitable user interface for this step.

At step 1002, the request can be updated based on changes received from a terminal or changes in data received from other system 132, 134.

Bids or other indications of interest are received from supplier parties, at step 1004. The request can be updated and bids can be received, at steps 1002 and 1004, until an award is made, at step 1006, or until the request expires (e.g., due to a selected time limit) or is cancelled by the requesting party, at step 1008. The system may include a chat subsystem to allow communications concerning the request between the requesting party and the relevant supplier parties. See FIGS. 18B and 18E-18H for suitable user interfaces for these steps.

If the chosen supplier does not accept the request, at step 1010, then the process returns to the previous loop to await another award, expiry, or cancellation. If the chosen supplier does accept the request, at step 1010, then the request is dispatched to one or more members of the supplier party who will undertake the actual work. The request may be transmitted to multiple members of the supplier party who each then have the option to begin work. See FIG. 18I for a suitable user interface for this step.

During performance of the request, data for the request is updated, at step 1012. Events are tracked and change data and unique data objects are captured from the terminal of the supplier party performing the request, at steps 1014, 1016. Updating data at step 1012 can include updating data, such as road/site conditions as obtained other system 132, 134. Tracking events and capturing data objects, at steps 1014, 1016, can be performed by the driver or other member of the supplier party using his/her terminal and its camera, voice recorder, or similar. See FIGS. 18J-18L for suitable user interfaces for these steps.

Steps 1012-1016 are repeated until the request is completed, at step 1018. An indication of request completion can be, for example, received from the supplier terminal used by the driver or other supplier party performing the work.

Another or the same member of the supplier party 1020 approves completion of the request and any changes thereto, at step 1020. A large supplier party may have various individuals with various roles and the process can be configured to assign various steps to various roles. In one example, a sales engineer approves the completion of the request as performed by a driver, field technician, or other individual. If the completion of the request is not approved, the relevant data, such as change data and cost data, can be rejected or revised, at step 1022. See FIGS. 18M and 18 N for suitable user interfaces for this step.

Once approved, an indication of the completed request with cost data is presented to the requesting party, at step 1024. This can include providing an electronic invoice to the requesting party. The completed request and cost data is presented such that the original cost/estimate is presented separately from any changes. See FIG. 18N for a suitable user interface for this step.

The requesting party can review captured data object supporting changes to the request, at step 1026. This can help support changes and increase their likelihood of approval. See FIG. 18M for a suitable user interface for this step.

Next, if the completed request with cost data is not approved, at step 1028, it can be rejected for revision by the supplier party, at step 1022. The system can be configured to prompt the requesting party for reason for the rejection to be displayed to the supplier party. It is recognized that a supplier party may have various individuals with various roles. One or more roles, which may belong to a role hierarchy, may be required to approve a completed request and its cost data, and such role(s) may be the same or different from the role(s) involved in creating the request.

If the completed request with cost data is approved, at step 1028, then the industrial project registration system is updated to mark the request as a historic request. Further, other systems, such as third-party accounting or project management systems, can be updated. This can be achieved, via API communications or similar between the industrial project registration system and third-party systems.

The industrial project registration system can be configured to output data such as costs, costs of changes, number of awarded bids, and related metrics compared to requesting party, or member thereof, and supplier party, or member thereof. This can allow for in depth analysis of the company's operations, the market in general, and related trends. IF may be discovered that too few or too many suppliers are being invited to bids o that awards are being made arbitrarily or based on flawed or incorrect procedures. Moreover, this data allows requesting parties to monitor total cost, the number and frequency of changes, and costs of changes incurred by various supplier parties. Requesting parties are thus provided with objective data from which to make decisions. This can lead to a more fluid market, promote competition, and improve service. Supplier parties who perform well are rewarded with more business and faster payment.

Numerous techniques and advantages have been discussed above. It should be apparent that the present invention provides an efficient and improved way of conducting industrial projects. Data is tracked and stored, and then made available when needed in an efficient manner that preserves data consistency and integrity. Repeated entry of the same data is not required, and remote parties who need to provide data are given convenient tools to do so. Parties who need to make approvals are provided with data, in various forms including images and sound, directly from the suppliers undertaking a project. This can improve computer network efficiencies by reducing clarifying exchanges or back-and-forth communications between parties to obtain approval of the project. Cost data is stored and presented in a manner that speeds approval and payment to suppliers. For instance, storing and presenting an initial cost estimate separate from an overage cost due to unforeseen event allows for quick and efficient assessment of the total cost. Moreover, project data is stored in a manner that allows for unique and useful assessment of a company's performance and relationships with other companies.

While the foregoing provides certain non-limiting example embodiments, it should be understood that combinations, subsets, and variations of the foregoing are contemplated. The monopoly sought is defined by the claims.

1. A process for electronically communicating data pertaining to an industrial project among a plurality of parties, the process comprising:
receiving requirements data captured at a requesting party terminal for a project request, the project request conforming to a predetermined schema, the requirements data specifying an industrial project to be undertaken;
determining if the requirements data includes a unique identifier of a piece of industrial equipment involved in the project, and if the requirements data contains the unique identifier, then constructing a project history query containing the unique identifier and further executing the project history query at a project history database;
extracting project history data from any project history result received from the project history database in response to execution of the project history query, the project history data specifying at least one equipment attribute of the piece of industrial equipment used in a past successful project identified by the unique identifier, the past successful project being stored at the project history database in association with a success indicator received from a past requesting party terminal;
updating the project request to contain any project history data; and
transmitting the project request through a network to a plurality of supplier party terminals operated by a plurality of supplier parties for at least one supplier party of the plurality of supplier parties to undertake the industrial project using a piece of equipment having the at least one equipment attribute.

2. The process of claim 1, wherein the unique identifier comprises an equipment serial number.

3. The process of claim 1, wherein the unique identifier comprises a set of physical characteristics that fully defines a commodity payload.

4. The process of claim 1, further comprising:
constructing a location query containing one or more locations based on the requirements data, the one or more locations representative of one or more of a site of the industrial project and locations between sites of the industrial project;
executing the location query at a location database; and
extracting characteristic location data from any location query result received from the location database in response to execution of the location query, the characteristic location data specifying information about the one or more locations.

5. The process of claim 4, wherein the characteristic location data contains at least one of safety attributes and site attributes.

6. The process of claim 1, wherein the project further includes a move of a payload involving the piece of industrial equipment, the process further comprising:
constructing a route query containing origin data and destination data specified in the requirements data, the origin data representative of a payload origin and the destination data representative of a payload destination;
executing the route query at a road database; and
extracting road data from any road query result received from the road database in response to execution of the route query, the road data specifying at least one road attribute of at least one road forming at least part of a route between the payload origin and the payload destination, the at least one road attribute including one or more of a road weight limit, a road dimension limit, and a road restriction indication.

7. The process of claim 6, further comprising updating the project request based on the road data.

8. The process of claim 6, periodically performing the constructing of a route query, the executing the route query, and the extracting road data, the process further comprising storing extracted road data for reference by a future project request.

9. The process of claim 6, further comprising:
receiving the road data as captured at a wireless estimator terminal; and
storing the road data.

10. The process of claim 1, further comprising storing the requirements data in the project history database is association with a supplier identifier of the at least one supplier party and an actual cost attributed to the at least one supplier party.

11. (canceled)

12. A process for recording planned and actual data pertaining to an industrial project, the process comprising:
receiving requirements data containing one or more locations representative of one or more of a site of the industrial project and locations between sites of the industrial project, the requirements data further identifying a piece of industrial equipment;
while the industrial project is being carried out by one or more supplier parties, receiving from a remote terminal change data, the change data representative of a change to the industrial project as requested by a supplier party;
accumulating change data during progression of the industrial project to obtain actual project data;
computing a value of the requirements data excluding the change data;
computing a value of the actual project data including the change data;
triggering an exception when the values differ by a threshold; and
storing the exception in a long-term memory device.

13. The process of claim 12, further comprising transmitting the exception to at least one remote terminal geographically removed from the piece of industrial equipment.

14. The process of claim 12, wherein receiving change data comprises receiving detour data from a remote terminal, the detour data indicative of an actual road condition affecting a move portion of the project as defined by the requirements data.

15. The process of claim 12, wherein receiving change data comprises receiving weather data, the weather data indicative of actual weather affecting the project as defined by the requirements data.

16. The process of claim 12, wherein receiving change data comprises receiving an image from a remote terminal positioned in geographical vicinity to the piece of industrial equipment, the image indicative of an actual physical circumstance affecting the project as defined by the requirements data.

17. The process of claim 16, wherein the change data further comprises geographic coordinates encoded in the image.

18. The process of claim 17, further comprising verifying the change data by comparing the geographic coordinates of the image to geographic coordinates defined by the requirements data.

19. The process of claim 12, wherein receiving change data comprises receiving a voice message from a remote terminal positioned in geographical vicinity to the piece of industrial equipment, the voice message indicative of an actual physical circumstance affecting the project as defined by the requirements data.

20. The process of claim 12, wherein receiving change data comprises receiving a text message from a remote terminal positioned in geographical vicinity to the piece of industrial equipment, the text message indicative of an actual physical circumstance affecting the project as defined by the requirements data.

21. The process of claim 12, wherein the value of the requirements data and the value of the actual project data include representations of planned and actual project time.

22. The process of claim 12, wherein the value of the requirements data and the value of the actual project data include representations of planned and actual project cost.

23. The process of claim 12, further comprising receiving an indication of approval or denial of an element of change data, and storing the element of change data in association with the indication of acceptance or rejection.

24. The process of claim 23, further comprising computing a total cost for the project based on an original bid and any approved elements of change data.

25. The process of claim 12, further comprising receiving sensor data from a remote sensor to determine a measured attribute of a supplier party.

26. The process of claim 25, further comprising storing the measured attribute in association with an element of change data.

27. The process of claim 25, further verifying the element of change data based on the measured attribute.

28. The process of claim 25, wherein the remote sensor is a GPS sensor installed in a vehicle of a supplier party, the process further comprising comparing the sensor data to a geo-fence of a payload origin defined in the requirements data to verify supplier presence at the payload origin.

29. The process of claim 25, wherein the remote sensor is a GPS sensor installed in a vehicle of a supplier party, the process further comprising comparing the sensor data to a geo-fence of a payload destination defined in the requirements data to verify supplier presence at the payload destination.

30. The process of claim 25, wherein the remote sensor is a GPS sensor installed in a vehicle of a supplier party, the process further comprising comparing the sensor data to a geo-fence of a portion of a move route defined in the requirements data to verify supplier compliance with the route or any detour defined in the change data.

31. A process for recording planned and actual data pertaining to an industrial project, the process comprising:
receiving from a requesting party terminal requirements data containing one or more locations representative of one or more of a site of the industrial project and locations between sites of the industrial project, the requirements data further identifying a commodity or piece of industrial equipment for a project request to be performed for the industrial project;
receiving an indication of initial cost data from one or more supplier party terminals operated by one or more supplier parties who will undertake a project request of the industrial project;
while the project request is being carried out by the one or more supplier parties, receiving from a remote supplier terminal via a network change data, the change data representative of an unforeseen change to the project request as requested by a supplier party;
associating the change data with actual cost data;
storing the actual cost data separately from the initial cost data; and
separately communicating the initial cost data and the actual cost data to the requesting party terminal or another requesting party terminal via the network.

32. (canceled)
